(19) United States
(12) Patent Application Publication
(10) Pub. No.: US 2022/0229622 A1
(43) Pub. Date: Jul. 21, 2022

(54) INFORMATION PROCESSING APPARATUS, CONTROL METHOD OF INFORMATION PROCESSING APPARATUS, AND STORAGE MEDIUM

(71) Applicants: CANON MARKETING JAPAN KABUSHIKI KAISHA, Tokyo (JP); CANON IT SOLUTIONS KABUSHIKI KAISHA, Tokyo (JP)

(72) Inventors: Mitsuhiro Seino, Tokyo (JP); Go Takatsuka, Tokyo (JP)

(21) Appl. No.: 17/579,996

(22) Filed: Jan. 20, 2022

(30) Foreign Application Priority Data
Jan. 21, 2021 (JP) 2021-007670
Nov. 29, 2021 (JP) 2021-192805

(51) Int. Cl. G06F 3/14; G09G 5/00; G09G 5/18; G06F 9/451

(52) U.S. Cl. CPC G06F 3/1415; G06F 3/1407; G06F 9/451; G09G 5/18; G09G 5/006

(57) ABSTRACT

According to one aspect of the present disclosure, an information processing apparatus comprises at least one memory and at least one processor which function as: a display unit configured to perform control to display a window displayed by application software; and a control unit configured to perform control to, in response to execution of a particular operation corresponding to an operation to provide an instruction for execution of a particular process, display a predefined display content while displaying the window without executing the particular process, wherein the control unit is further configured to perform control to, in response to occurrence of the particular operation, display a predetermined display item for a predetermined time before displaying the predefined display content and then display the predefined display content, and the predetermined display item indicates that processing latency is ongoing.

### BACKGROUND

### Field of the Disclosure

The present disclosure relates to an information processing apparatus, a control method of an information processing apparatus, and a storage medium used for virtually reproducing an operation of application software.

### Description of the Related Art

In creating application software for a customer, it is possible to reduce rework to increase design efficiency if a designer first hears requests from the customer and then creates the application software.

In particular, unlike internal logic circuits, if windows, operation procedures, or the like work as requested by the user, this will result in increased customer satisfaction.

Japanese Patent Application Laid-Open No. 2015-210639 discloses a technology that achieves the object described above by finalizing requirements as requested while hearing requests from the user and, at the same time, instantly generating and completing a source code of an application program that may be used for an actual device.

Japanese Patent Application Laid-Open No. 2015-210639 discloses generation of a mock-up file of application software and generation of a source code of mock-up application software to implement mock-up window transition. Since window transition of the generated mock-up application software is loaded from a web server, however, it takes time for the window transition, and this results in inefficient development in a development environment. On the other hand, if the mock-up application software is formed of application software that operates only on a client, prototype (trial) application software will need to be executed in an environment not in communication with a server, and it is thus not easy to reproduce latency such as data communication time, calculation time taken by the server, or the like occurring in window transition in the actual implementation.

### SUMMARY OF THE DISCLOSURE

An aspect of the present disclosure provides virtual feeling of latency due to a time required for a process when virtually reproducing an operation of application software.

According to one aspect of the present disclosure, an information processing apparatus comprises at least one memory and at least one processor which function as:
a display control unit configured to perform control to display a window displayed by application software; and
a control unit configured to perform control to, in response to execution of a particular operation corresponding to an operation to provide an instruction for execution of a particular process, display a predefined display content while displaying the window without executing the particular process,
wherein the control unit is further configured to perform control to, in response to occurrence of the particular operation, display a predetermined display item for a predetermined time before displaying the predefined display content and then display the predefined display content, and the predetermined display item indicates that processing latency is ongoing.

Further features of various embodiments will become apparent from the following description of exemplary embodiments with reference to the attached drawings.

### BRIEF DESCRIPTION OF THE DRAWINGS

FIG. 1 is a diagram of a system configuration illustrating an example of a configuration of a program development apparatus, an execution server, a database server, and a client apparatus of the present embodiment.

FIG. 2 is a block diagram illustrating an example of each hardware component applicable as the program development apparatus, the execution server, the database server, and the client apparatus of the present embodiment.

FIG. 3 is an example of software components of the present embodiment.

FIG. 4 is a function configuration diagram of the program development apparatus of the present embodiment.

FIG. 5 is a flowchart of generation of prototype application software of the present embodiment.

FIG. 6 is a flowchart of a process of accepting window definition input of the present embodiment.

FIG. 7 is a flowchart of a process of accepting prototype data input of the present embodiment.

FIG. 8 is a flowchart of a process of generating a source code of prototype application software of the present embodiment.

FIG. 9 is a flowchart of a process when the prototype application software of the present embodiment is executed.

FIG. 10 is an example of window display of the present embodiment.

FIG. 11 is an example of window display of the present embodiment.

FIG. 12 is an example of window display of the present embodiment.

FIG. 13 is an example of window display of the present embodiment.

FIG. 14 is an example of window display of the present embodiment.

FIG. 15 is an example of window display of the present embodiment.

FIG. 16 is an example of window display of the present embodiment.

FIG. 17 is an example of window display of the present embodiment.

FIG. 18 is an example of window display of the present embodiment.

FIG. 19 is an example of window display of the present embodiment.

FIG. 20 is an example of window display of the present embodiment.

FIG. 21 is a diagram illustrating an example of a window definition 402 of the present embodiment.

FIG. 22 is a diagram illustrating an example of the window definition 402 of the present embodiment.

FIG. 23 is a diagram illustrating an example of control of the window size of a prototype application window 442 of the present embodiment.

FIG. 24 is a diagram illustrating an example of window display of the prototype application window 442 of the present embodiment.

FIG. 25 is a diagram illustrating a relationship between prototype application windows and a prototype operation panel of the present embodiment.

FIG. 26 is a flowchart of a process when the prototype application software of the present embodiment is executed.

FIG. 27 is a flowchart of a process when the prototype application software of the present embodiment is executed.

FIG. 28 is a flowchart of a process when the prototype application software of the present embodiment is executed.

FIG. 29 is a flowchart of a process when the prototype application software of the present embodiment is executed.

FIG. 30 is a diagram illustrating an example of a device that can be displayed on a browser of the present embodiment.

FIG. 31 is an example of window display of the present embodiment.

FIG. 32 is an example of window display of the present embodiment.

FIG. 33 is an example of window display of the present embodiment.

FIG. 34 is an example of window display of the present embodiment.

FIG. 35 is an example of window display of the present embodiment.

### DESCRIPTION OF THE EMBODIMENTS

Embodiments of the present disclosure will be described in detail below with reference to the drawings.

### First Embodiment

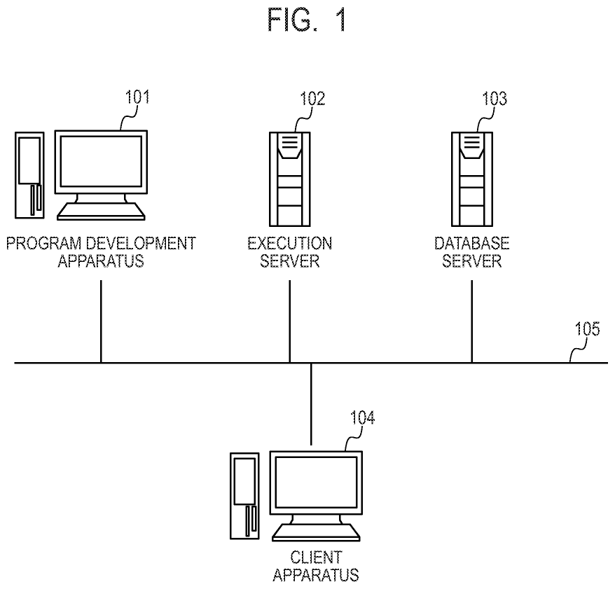

FIG. 1 is a diagram of a system (information processing system) configuration illustrating an example of a configuration of a program development apparatus (an information processing apparatus operated by a developer for generating web application software), an execution server, a database server, and a client apparatus of the present embodiment.

A program development apparatus 101 defines a window layout, a database search instruction, and the like in accordance with an operation performed by a developer. The program development apparatus 101 generates application software including a program.

Note that, although the application software to be generated by the program development apparatus 101 is application software on a web in this embodiment, the application software to be generated is not limited thereto and may not necessarily be application software using web technology-based communication, such as application software, embedded software, or the like operated on an information processing apparatus such as a mobile phone, a smartphone, a tablet, or the like.

An execution server 102 executes application software (an application program included in application software) developed by the program development apparatus 101. Further, the execution server 102 can be operated in connection with a database server 103.

The database server 103 is a database used by the developed application software and, in the present embodiment, may also be utilized for reviewing operations or the like during development. For example, the database server 103 may be formed of the same apparatus as the program development apparatus 101 or the execution server 102 or may be arranged inside a network 105 such as a LAN for use by the developer.

A client apparatus 104 (information processing apparatus) is an end user's input terminal that operates an application program developed by the program development apparatus 101 in cooperation with the execution server 102. The client apparatus 104 may be an information processing apparatus such as a mobile phone terminal.

Note that some of the program development apparatus 101, the execution server 102, the database server 103, and the client apparatus 104 may be arranged on the Internet such as a cloud, or some of the information processing apparatuses may be contained in a single casing.

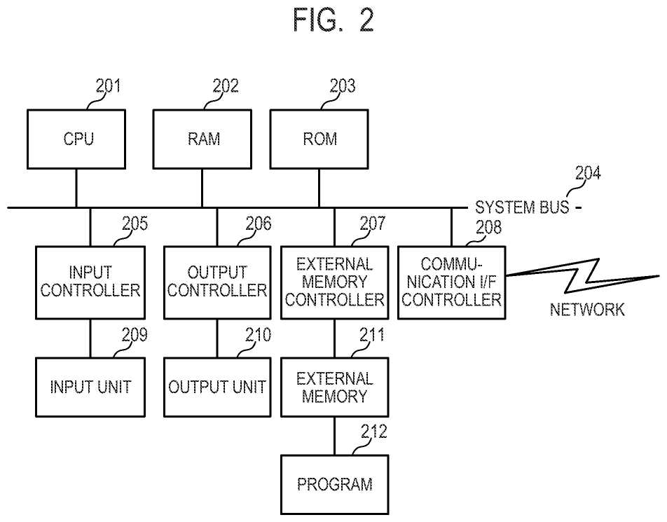

FIG. 2 is a block diagram illustrating an example of each hardware component applicable as the program development apparatus 101, the execution server 102, the database server 103, and the client apparatus 104 of the present embodiment.

In FIG. 2, a CPU 201 is at least one processor and integrally controls each device connected to a system bus 204.

Further, a ROM 203 or an external memory 211 stores operating system (OS), which is a control program of the CPU 201, or programs used for implementing respective functions described later of information processing apparatuses such as each server, each client, each apparatus, or the like. The ROM 203 or the external memory 211 is at least one memory.

A RAM 202 functions as a main memory, a work area, a temporary save region, or the like for the CPU 201.

An input controller 205 controls input from an input unit 209. The input unit 209 may be a keyboard, a pointing device such as a mouse, or a touch panel in the information processing apparatus.

Note that, when the input unit 209 is a touch panel, various instructions can be provided when the user presses (touches by a finger or the like) an icon, a cursor, or a button displayed on the touch panel.

Further, the touch panel may be a touch panel, such as a multi-touchscreen that can detect positions touched by multiple fingers.

An output controller 206 controls display on an output unit 210. The output unit 210 may be, for example, a CRT, a liquid crystal display, or the like. Note that the output unit 210 may also be a display integrated with the main unit of a laptop personal computer. Further, the output unit 210 may also be a projector.

An external memory controller 207 controls access to the external memory 211 that stores a boot program, various application software, font data, a user file, an edition file, a printer driver, or the like. The external memory 211 stores various tables and parameters used for implementing various functions of each server, each client apparatus, and the like. The external memory 211 may be a hard disk (HD), a flexible disk (FD), a compact flash (registered trademark) connected to a PCMCIA card slot via an adapter, a smart media, or the like.

Note that the CPU 201 executes a process of an outline font expansion (rasterizing) to a display information region in the RAM 202, for example, and thereby enables display on the output unit 210. Further, the CPU 201 enables a developer to provide an instruction by using a mouse cursor (not illustrated) or the like on the output unit 210.

A communication I/F controller 208 executes a control process of communication with an external device via a network. For example, communication using TCP/IP or the like are possible.

A program 212 for implementing the present embodiment is stored in the external memory 211 and executed by the CPU 201 when loaded into the RAM 202 if necessary.

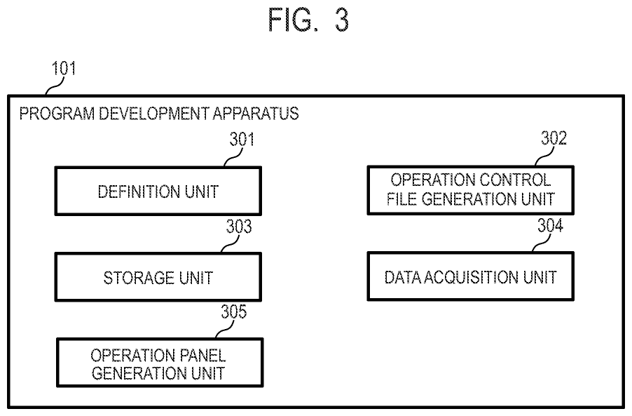

FIG. 3 is an example of a block diagram illustrating software components of the present embodiment.

The program development apparatus 101 has the following function units.

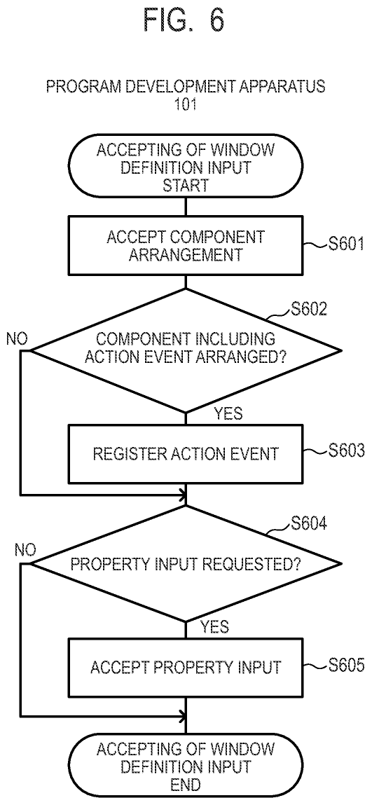

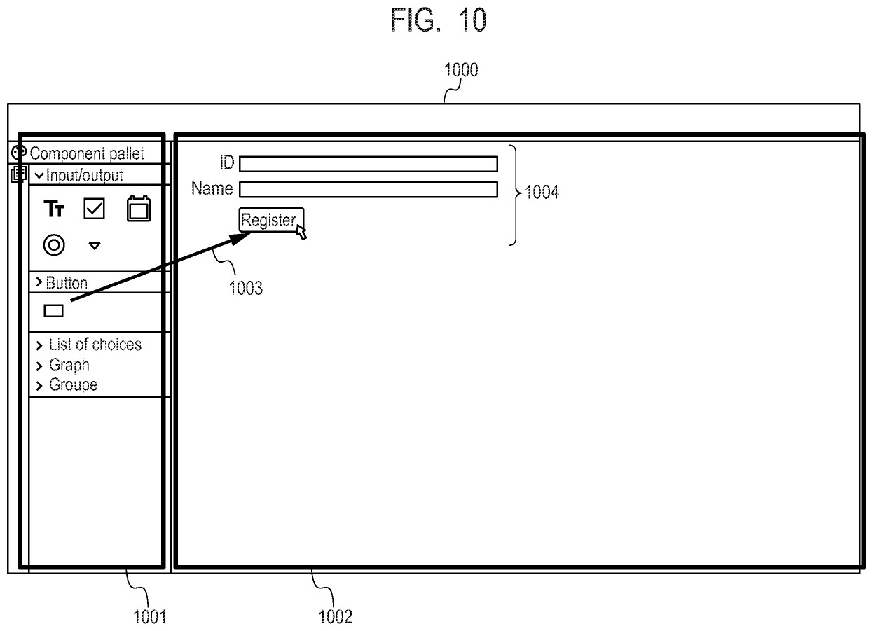

A definition unit 301 is a function unit that accepts, from a developer, window definition information on a window displayed in the application software, arrangement of items (input/output items), or the like and window transition definition information that defines a procedure of transition from a window of the application software to the next window, and specifically, the flowchart of FIG. 6 and illustration diagrams of FIG. 10 to FIG. 14 apply to the above function unit.

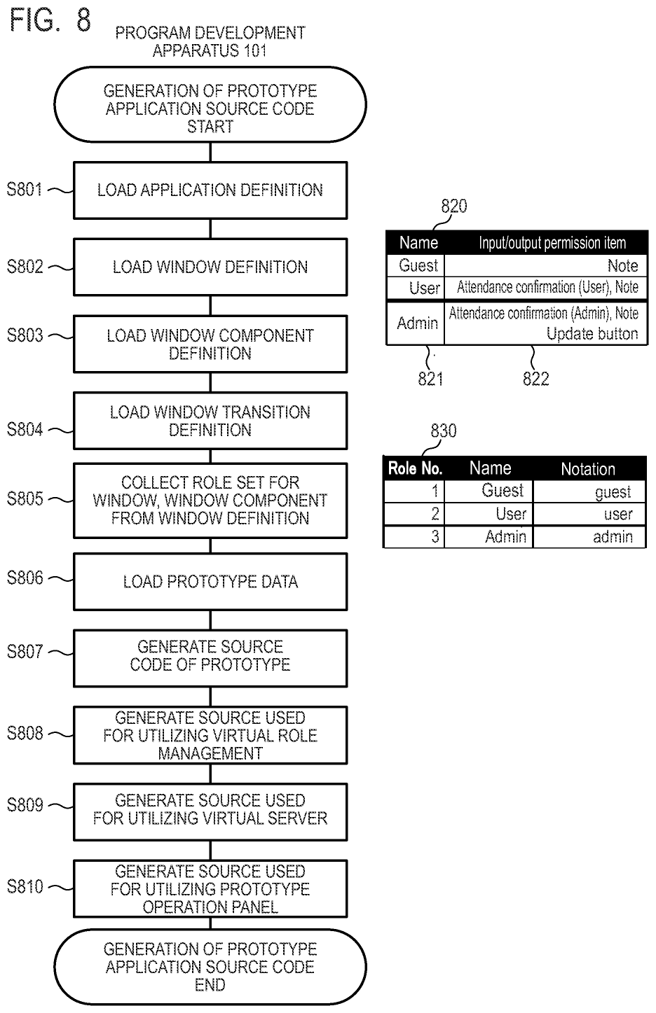

An operation control file generation unit 302 is a function unit that generates a prototype application (operation control file) used for virtually reproducing (previewing) a window defined by the definition unit 301 and a procedure of transition between windows, and specifically, the process of the flowchart of FIG. 8 applies to the above function unit.

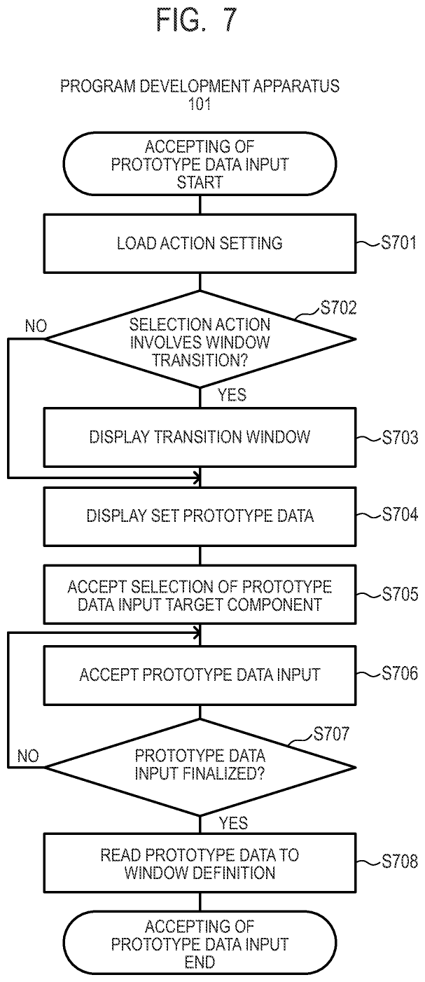

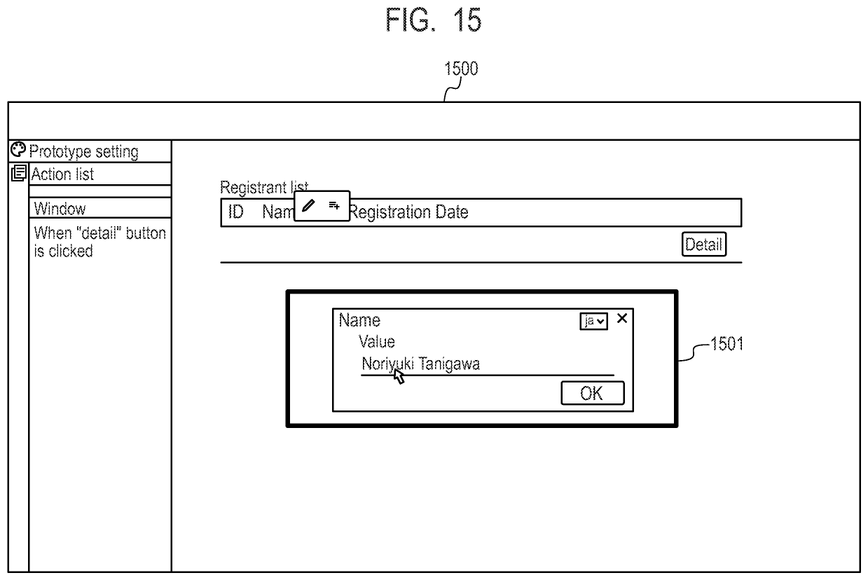

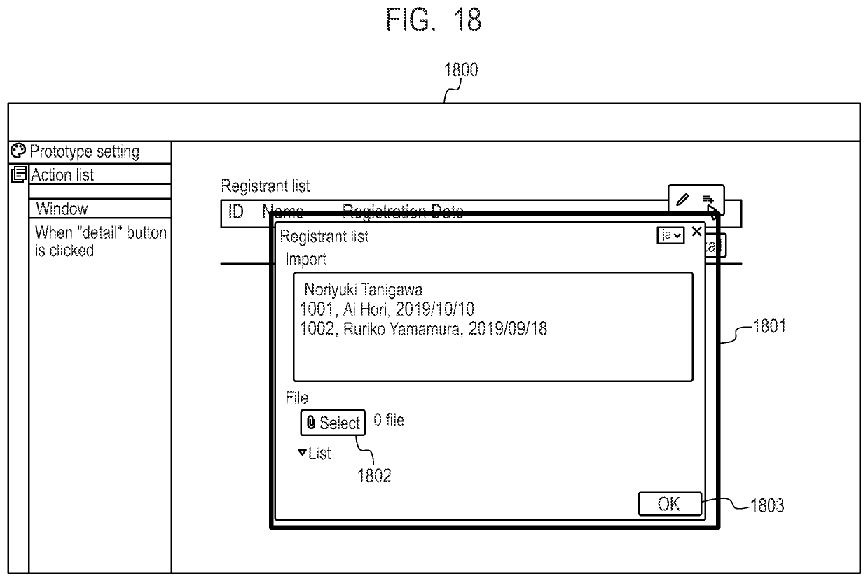

A data acquisition unit 304 is a function unit that acquires, from the user, data to be displayed in an item (input/output item) on the prototype application, and specifically, step S706 of FIG. 7 and illustration diagrams of FIG. 15 and FIG. 18 apply to the above function unit.

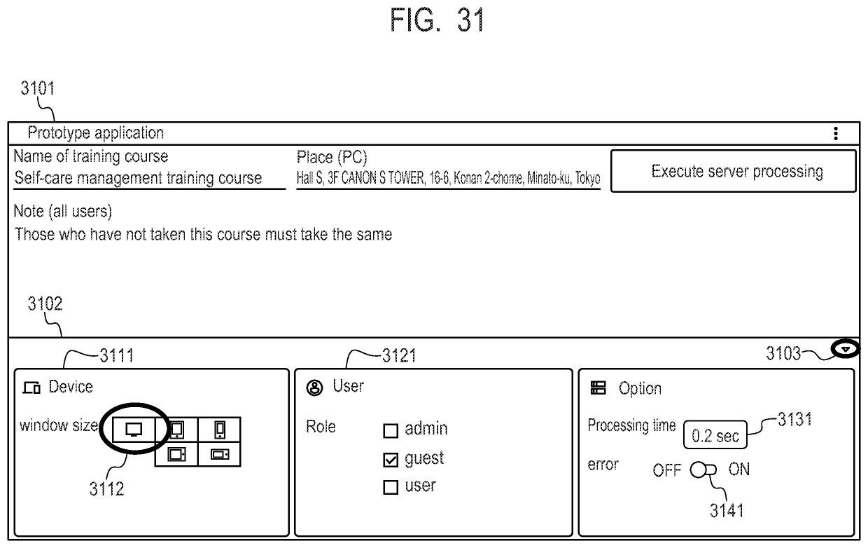

An operation panel generation unit 305 is a function unit that generates a prototype operation panel used for controlling a window environment, a transition scheme, or the like of the prototype application and specifically is a function unit that perform the process of step S810 of FIG. 8. The generated prototype operation panel is a prototype operation panel 3102 of FIG. 31 or the like.

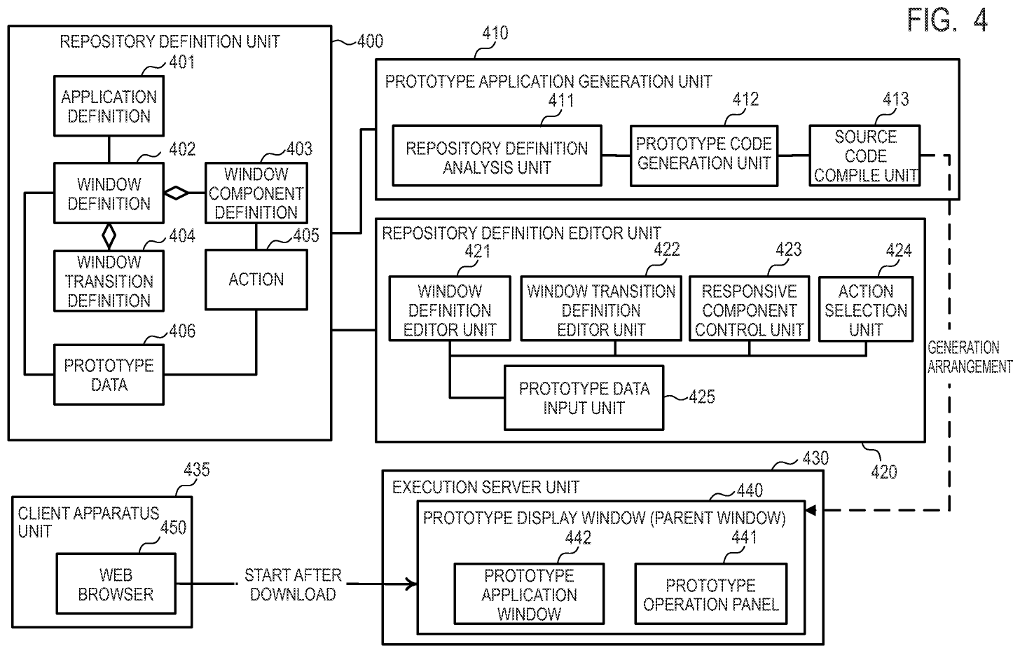

FIG. 4 is a configuration diagram of the program development apparatus 101, the execution server 102, and the client apparatus 104.

The program development apparatus 101 includes a repository definition unit 400, a prototype application generation unit 410, and a repository definition editor unit 420. Note that, unlike application software used for searching a database for data as with the actual environment or drawing a diagram from a calculated data result, the prototype application of the present embodiment is application software as a mock-up used for displaying a value that has been set in advance or a diagram that has been drawn in advance or the like or emulating window transition, display change, or the like in the same manner as the actual application software.

The execution server 102 corresponds to an execution server unit 430 in FIG. 4, and the client apparatus 104 includes a client apparatus unit 435.

The program development apparatus 101 uses a prototype application generation unit 410 to generate a source code of software (prototype application) used for displaying a prototype display window 440 (a display window caused by prototype application). A developer in the present embodiment widely refers to those who use the program development apparatus 101, such as a business user or a sales representative, without being limited to a contract developer for application software.

The repository definition unit 400 stores an application definition 401, a window definition 402, a window component definition 403, a window transition definition 404, an action 405 associated with the window component definition 403, and prototype data 406 associated with the action 405. The prototype data refers to data displayed on an application software window when the prototype application is executed and refers to a value or a diagram set in advance by a developer rather than those resulted by searching a database for data as with the actual environment or drawing a diagram from a calculated data result. These definitions of 401 to 406 are input and set or arranged by the developer via an application software development tool.

The application definition 401 holds settings of the entire application software to be developed by the developer.

The window definition 402 holds information on the various window component definition 403 and the window transition definition 404 arranged in each window included in the application software. The window definition 402 includes information on the action 405 set for various components and the prototype data 406 associated with the action 405.

The prototype application generation unit 410 analyzes the repository definition unit 400 set by the developer and generates a source code of software used for displaying the prototype display window 440 (prototype application). Further, after generating the prototype application, the prototype application generation unit 410 deploys, to the execution server unit 430, the source code of the software used for displaying the prototype display window 440 (prototype application).

A repository definition analysis unit 411 analyzes the repository definition unit 400 set by the developer.

A prototype code generation unit 412 generates a source code of a prototype application in accordance with the analysis result from the repository definition analysis unit 411.

A source code compile unit 413 compiles a source code generated by the prototype code generation unit 412 and deploys, to the execution server unit 430, instruction information used for displaying the prototype display window 440 including a compiled Java (registered trademark) code and HTML/JSP/JavaScript (registered trademark).

A repository definition editor unit 420 is an example of the procedure for the user to set the repository definition unit 400. The repository definition editor unit 420 includes a window definition editor unit 421, a window transition definition editor unit 422, a responsive component control unit 423, an action selection unit 424, and a prototype data input unit 425.

The window definition editor unit 421 is a graphical editor for the developer to intuitively create a desired window layout.

The window transition definition editor unit 422 is an editor for the developer to set properties for each arranged window component.

The responsive component control unit 423 is a function unit by which the developer controls a display format (arrangement of a window or a component width) of window components on a client window width basis.

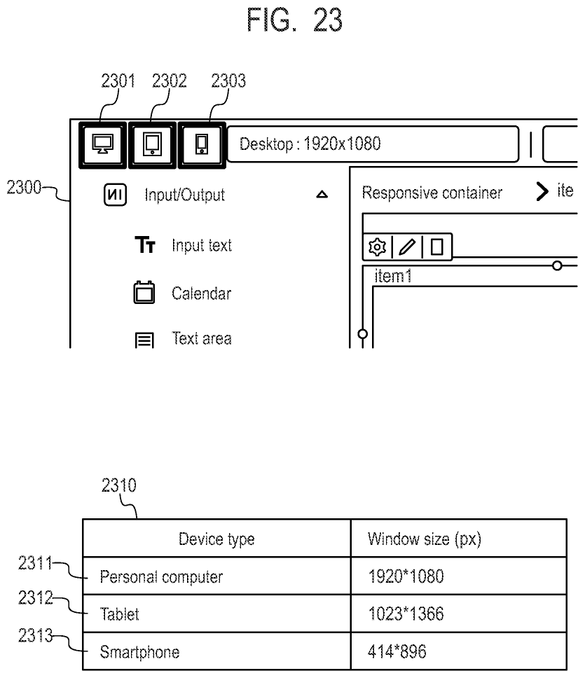

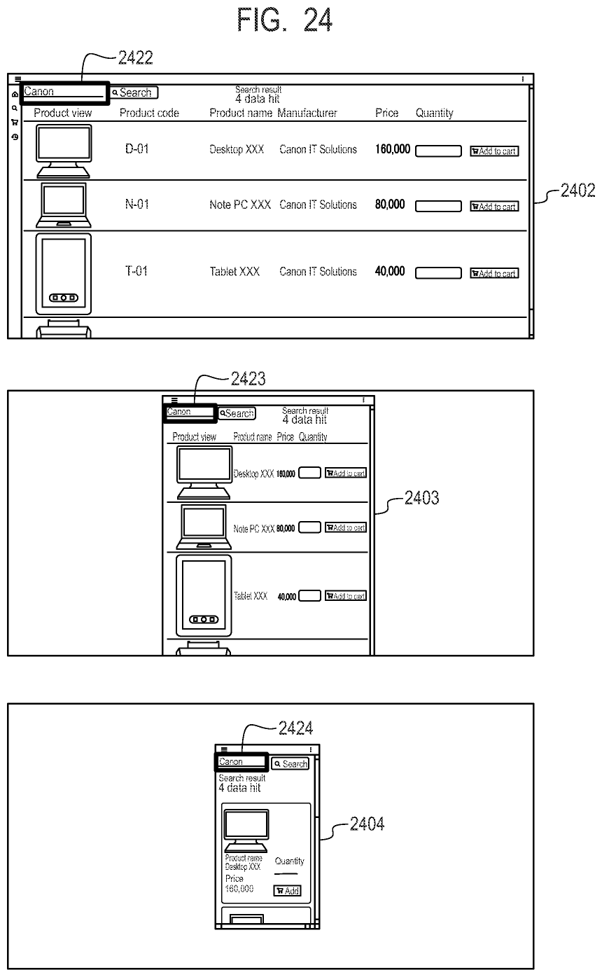

An example of the responsive component control unit 423 will be described with reference to FIG. 23 and FIG. 24.

FIG. 23 is a schematic diagram illustrating control of the window size of the prototype application window 442 of the present embodiment.

For example, as with a display example 2300 of FIG. 23, switch buttons such as a personal computer (PC) screen button 2301, a tablet screen button 2302, and a smartphone screen button 2303 used for switching multiple types of client display windows are displayed in the generation window of the application software.

Data storing the window size displayed on the client apparatus 104 when the switch button of the display example 2300 is pressed corresponds to information 2310. For example, the window size to be displayed is 1920×1080 (2311) when the PC screen button 2301 is pressed, the window size to be displayed is 1023×1366 (2312) when the tablet screen button 2302 is pressed, and the window size to be displayed is 414×896 when the smartphone screen button 2303 is pressed. Display examples of a window displayed in response to respective buttons being pressed will be described with reference to FIG. 24.

FIG. 24 is a display example illustrating an example of window display of the prototype application window 442 of the present embodiment.

For example, a window region 2402 of FIG. 24 is a display example of a PC screen, a window region 2403 is a display example of a tablet screen, and a window region 2404 is a display example of a smartphone screen. The window region 2402 represents a simulated display screen when the application program for actual implementation was executed by a PC, which is at least a part of the whole region of the display of the client apparatus 104 and is a region of 1920 pixels wide by 1080 pixels high defined as a PC screen size in the information 2310. The window region 2403 represents a simulated display screen when the application program for actual implementation was executed by a tablet, which is at least a part of the whole region of the display of the client apparatus 104 and is a region of 1023 pixels wide by 1366 pixels high defined as a tablet screen size in the information 2310. The window region 2404 represents a simulated display screen when the application program for actual implementation was executed by a smartphone, which is at least a part of the whole region of the display of the client apparatus 104 and is a region of 414 pixels wide by 896 pixels high defined as a smartphone screen size in the information 2310. Regarding respective component sizes, for example, a component 2422 (displayed component) of a window region 2402 representing a PC screen corresponds to a component 2423 in the window region 2403 representing a tablet screen and corresponds to a component 2424 in the window region 2404 representing a smartphone screen. The responsive component control unit 423 controls the components 2422, 2423, and 2424, which are the same components, to be displayed at a predetermined ratio relative to the whole horizontal width of the window regions (2402, 2403, 2404), respectively, as illustrated in FIG. 24. That is, the components of 2402 are controlled such that the component 2422 is displayed at a ratio of 2/12 of the entire window region 2402 in the PC screen, the component 2423 is displayed at a ratio of 3/12 of the entire window region 2403 in the tablet screen, and the component 2424 is displayed at a ratio of 6/12 of the entire window region 2404 in the smartphone screen. Reference is now made back to the description of the configuration diagram of FIG. 4.

The action selection unit 424 is a function unit that selects an action (an action event) by which the developer selects an action of interest for which the prototype data 406 is set.

The prototype data input unit 425 is a graphical editor used for intuitively setting the prototype data 406 associated with a particular action 405.

The execution server unit 430 (102) is a function unit that stores instruction information (prototype application) used for displaying the prototype display window 440 generated by the prototype application generation unit 410 and transmits the instruction information to the client apparatus 104.

The prototype display window 440 is a display window caused by the prototype application generated by the prototype application generation unit 410. The prototype display window 440 is a display window caused by the prototype application by which a user such as a business user (customer decision maker) or a sales representative who makes a proposal to a customer reproduces and displays display contents, operations, or the like of application software generated by the program development apparatus 101 during development of application software. The prototype display window 440 includes a prototype operation panel 441 and a prototype application window 442.

The prototype operation panel 441 is a module having a function of a user interface of the prototype display window 440 and is a panel (screen) that accepts, from the developer, settings of reproduction of the window size of the client apparatus 104, reproduction of a display image on a user authority basis, reproduction of process latency at a server, reproduction of a display window when an error occurs at a server, or the like.

The prototype application window 442 is a region in which display contents, operations, or the like of application software generated by the program development apparatus 101 are reproduced and displayed.

The client apparatus unit 435 downloads data used for displaying the prototype display window 440 from the execution server unit 430. The client apparatus unit 435 uses the web browser 450 to display the prototype display window 440 formed of a single page application (SPA).

Further, although not illustrated, an application code generation unit that generates an actually operating application code instead of a prototype application is also provided. The actually operating application code is a code of application software for actual implementation. The application code generation unit loads the application definition 401, the window definition 402, a separately defined database definition, a data model definition, and a business process definition from the repository definition unit 400 and analyzes the loaded definitions by using the repository definition analysis unit 411. The web application code generation unit uses a code generation rule stored in the external memory 211 and the content analyzed by the repository definition analysis unit 411 to generate a web application module including a compiled Java (registered trademark) code and HTML/JSP/JavaScript (registered trademark) via the source code compile unit 413.

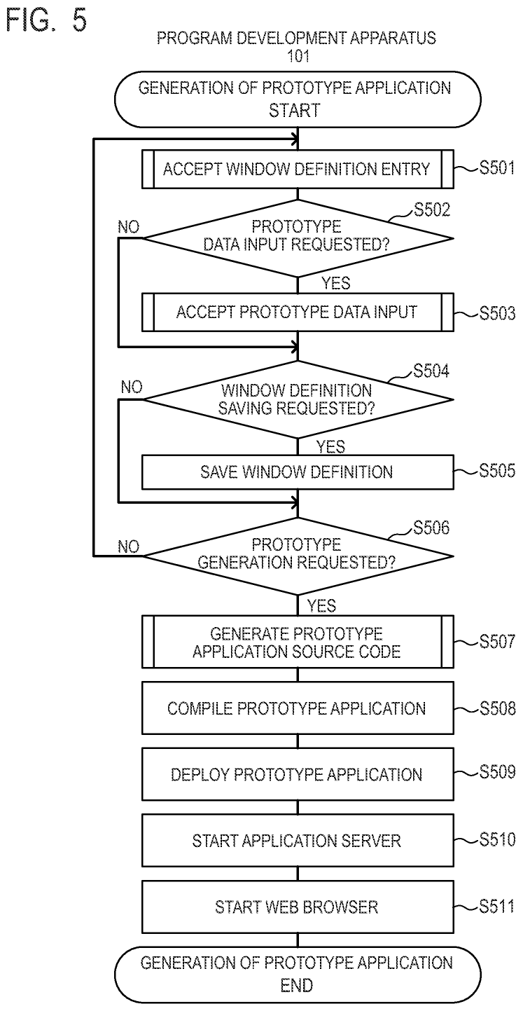

FIG. 5 is a diagram illustrating an example of a flowchart of generation of a prototype application of web application software. Note that each step of the flowchart described below is executed by the CPU 201 of the program development apparatus 101.

The flowchart of FIG. 5 represents a flow of the process started by the program development apparatus 101 when the developer intends to generate a prototype application.

First, in step S501, the program development apparatus 101 accepts input of a window definition. Details of the process of step S501 will be described later with reference to FIG. 6.

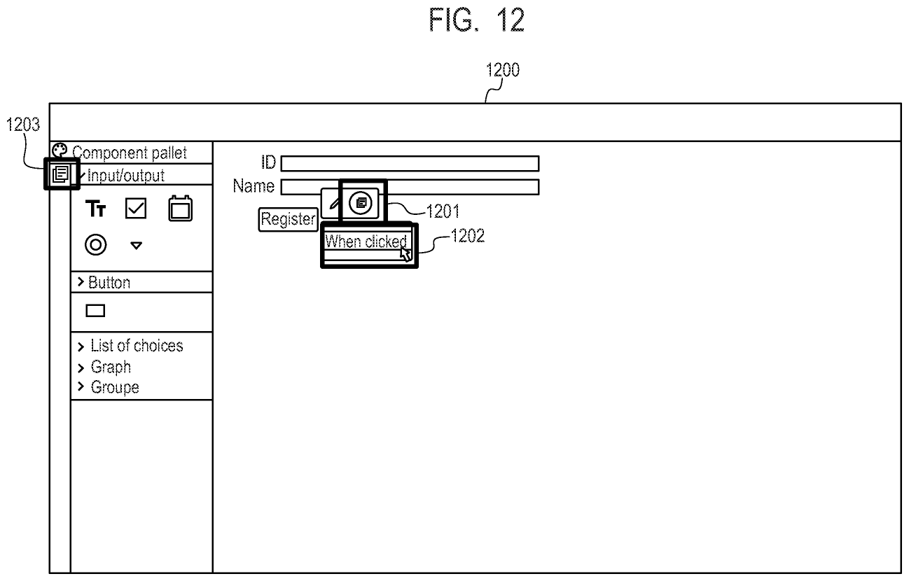

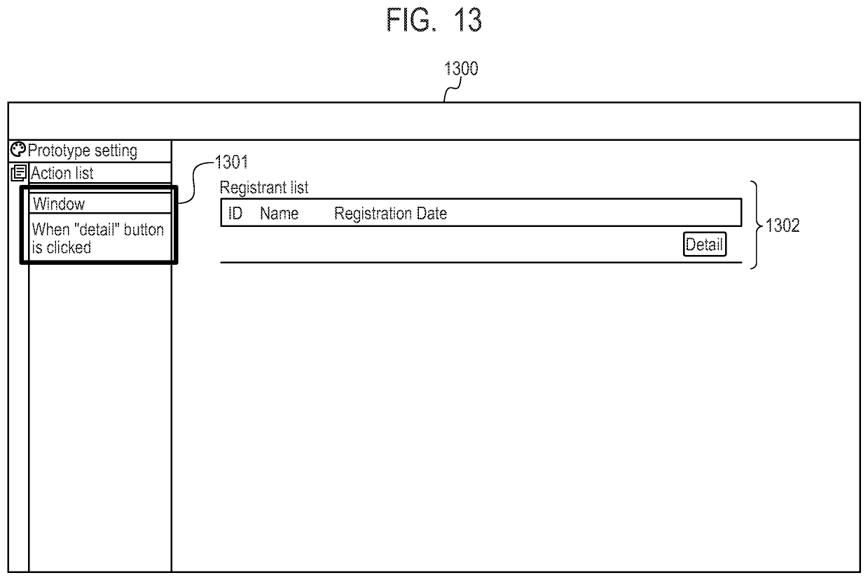

Next, in step S502, the program development apparatus 101 determines whether or not there is a request for input of the prototype data 443. Specifically, it is determined whether or not a display element 1201 (icon) and a display element 1202 (selected item) of FIG. 12, which correspond to an example of the action selection unit 424, or a display element 1203 (icon) and a display element 1301 (selected item) of FIG. 13 are pressed.

The action control module included in a prototype application controls which data to display out of a plurality of prototype data set by the developer at what timing in a period of execution of displaying the prototype display window 440. Further, the action control module controls an operation associated with each action responsible by a component arranged in the window. That is, the prototype data is associated with an action (an action event).

The program development apparatus 101 accepts the pressing in order to designate which action the prototype data to be input by the developer is associated with.

If it is determined in step S502 that there is a request for input of prototype data, the process proceeds to step S503.

In contrast, if it is determined in step S502 that there is no request for input of prototype data, the process proceeds to step S504.

Note that an example of the action selection unit caused when the display element 1201 is pressed is illustrated in the display element 1202. Further, an example of the action selection unit caused when the display element 1203 is pressed is illustrated in the display element 1301. Although the display element 1301 displays a list of actions included in the window definition being displayed, a list of actions included in an application definition may be displayed.

When proceeding to step S503, the program development apparatus 101 accepts input of prototype data from the developer. Details of the process of step S503 will be described later with reference to FIG. 7. The process then proceeds to step S504.

In step S504, the program development apparatus 101 determines whether or not there is a request for saving the window definition. If it is determined that there is a request for saving the window definition, the process proceeds to step S505, and if it is determined that there is no request for saving the window definition, the process proceeds to step S506.

When proceeding to step S505, the program development apparatus 101 saves the window definition in the repository definition unit 400. The process then proceeds to step S506.

When proceeding to step S506, the program development apparatus 101 determines whether or not there is a request for generating a prototype. If it is determined that there is a request for generating a prototype, the process proceeds to step S507. In contrast, if there is no request for generating a prototype, the process proceeds to step S501.

When proceeding to step S507, the program development apparatus 101 generates a source code of a prototype application. Details of the process of step S507 will be described later with reference to FIG. 7.

Next, in step S508, the program development apparatus 101 compiles the source code generated in step S507.

In step S509, the program development apparatus 101 deploys the prototype application compiled in step S508 to the execution server 102 (430).

The subsequent process will be described with an example in which the program development apparatus 101, the execution server 102, and the client apparatus 104 are implemented by the same information processing apparatus. When these apparatuses are separate information processing apparatuses, however, respective information processing apparatuses start respective application software (prototype applications, web browsers, or the like) and execute the process.

In step S510, the program development apparatus 101 starts the prototype application deployed to the execution server 102.

In step S511, the program development apparatus 101 starts a web browser and starts URL access of the prototype application. Note that the process of step S510 or S511 is an example when the program development apparatus 101 uses the execution server 102 and the client apparatus 104 in combination. When respective separate casings are used, the process of step S510 is executed by the execution server 102, and the process of step S511 is executed by the client apparatus 104.

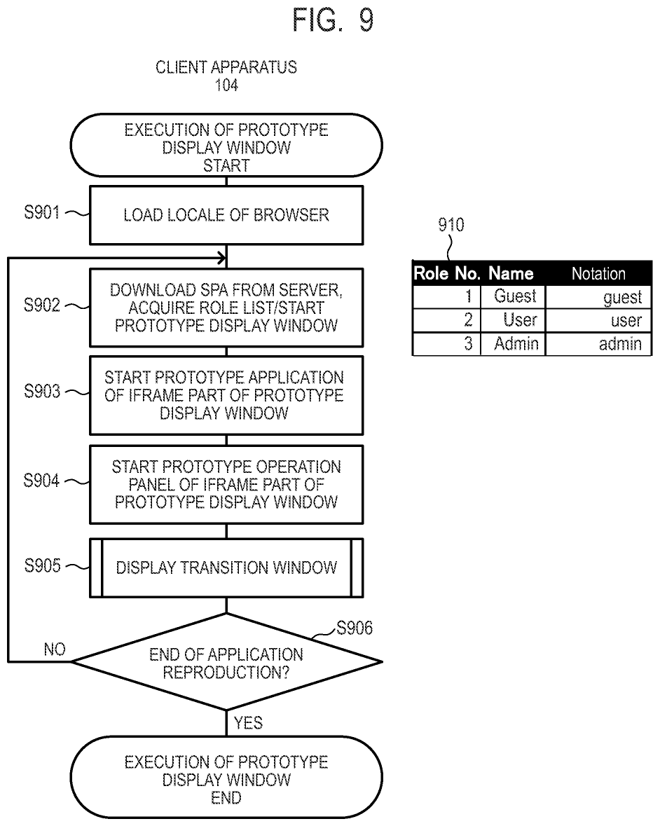

This is the end of the description for FIG. 5. The subsequent process will be described later with reference to FIG. 9. Note that, in the description for FIG. 9 and the subsequent drawings, the prototype application is executed by the client apparatus 104 that started the web browser, instead of the program development apparatus 101. However, the prototype application may be executed by the program development apparatus 101 that started the web browser in the same manner as the client apparatus 104.

Next, details of the process of step S501 will be described with reference to FIG. 6.

FIG. 6 is a diagram illustrating an example of a flowchart that accepts input of a window definition of web application software. Note that each step of the flowchart described below is executed by the CPU 201 of the program development apparatus 101.

The flowchart of FIG. 6 represents a flow of the process started when the process proceeds to step S501 in the flowchart of FIG. 5.

First, in step S601, the program development apparatus 101 accepts arrangement of a window component from the developer. Specifically, the program development apparatus 101 accepts arrangement of a component by drag and drop 1003 from a region 1001 (an example of the responsive component control unit 423) to a region 1002 (an example of window definition editor unit 421) of FIG. 10. FIG. 10 illustrates an example in which a button component is dragged and dropped from the responsive component control unit to the window definition editor unit. The method of arranging a window component is not limited to drag and drop from the responsive component control unit 423 to the window definition editor unit 421 and may be a method of moving an already arranged component or a method of duplicating an already arranged component by copy and paste. Further, a component once arranged may be deleted.

The case of FIG. 10 illustrates an example in which a window (a window in application software to be generated) provided with two text entry fields (an ID entry field and a name entry field) and a registration button used for registering an ID and a name is created as with an arrangement example 1004.

Next, in step S602, the program development apparatus 101 determines whether or not a component including an action event has been arranged. If it is determined that a component including an action event has been arranged, the process proceeds to step S603, and if it is determined that no component including an action event has been arranged, the process proceeds to step S604.

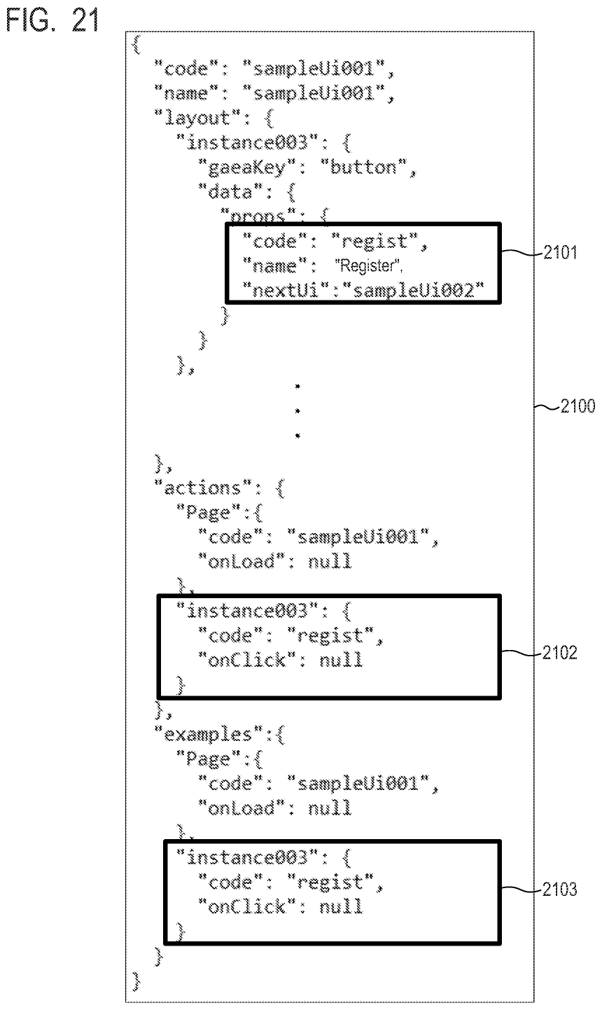

When proceeding to step S603, the program development apparatus 101 registers an action set in the component including an action event. Specifically, in a case of a component responsible for an action of onClick in the source code of the component, the action is registered. A definition 2102 of “actions” corresponding to the actual environment and a definition 2103 of “examples” corresponding to the prototype application are written out to definition information 2100 (source code) of FIG. 21 that is an example of the window definition 402. Note that, although the format for holding data is a json file as an example of a way of implementation in the example of FIG. 21, the format for holding data may be a file in another format or may be a database. The process then proceeds to step S604.

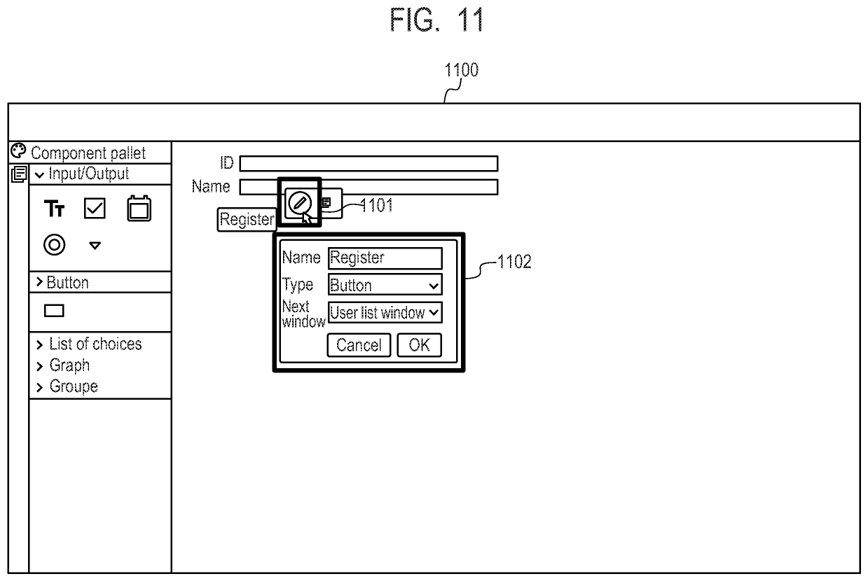

Next, in step S604, the program development apparatus 101 determines whether or not there is a request for inputting a property. Specifically, it is determined whether or not a display element 1101 (icon) of FIG. 11 that is an example of a property input request button of a selected component is pressed.

If it is determined that there is a request for inputting a property, the process proceeds to step S605, and if it is determined that there is no request for inputting a property, the process of accepting input of a window definition ends.

When proceeding to step S605, the program development apparatus 101 accepts input of a property for a window component from the developer. Specifically, the display element 1102 (dialog box) of FIG. 11 that is an example of a window property editor is displayed, and input of a setting for a property of the window component is accepted. Although a window property editor is displayed near the component in order to implement an intuitive operation made by the developer in the example of FIG. 11, a particular region in the window may be secured for the window property editor. Further, the window property editor may be displayed with a modal dialog.

This is the end of the description of FIG. 6.

Next, details of the process of step S503 will be described with reference to FIG. 7.

FIG. 7 is a diagram illustrating an example of a flowchart that accepts input of prototype data displayed in a window when generating a prototype application of web application software. Note that each step of the flowchart described below is executed by the CPU 201 of the program development apparatus 101.

The flowchart of FIG. 7 represents a flow of the process started when the process proceeds to step S503 in the flowchart of FIG. 5.

First, in step S701, the program development apparatus 101 loads settings of an action item designated by the developer in step S502 of FIG. 5. Specifically, the following two operations are performed. First, the arrangement example 1004 of FIG. 10 that is an example of the window component definition 403 of a window component selected by the developer is defined, and a definition 2101 of FIG. 21 is loaded. The data of the definition 2101 is the data input from 1102 of FIG. 11 in step S605 of the flowchart of FIG. 6. Next, a definition 2102 of “actions” corresponding to the actual environment of the window component selected by the developer and a definition 2103 of “examples” corresponding to the prototype application are loaded.

Next, in step S702, the program development apparatus 101 determines whether or not the setting of the action item loaded in step S701 involves window transition. Specifically, it is determined whether or not a value is set in the “nextUi” property (the next window property in 1102) that is an example of the window transition definition 404 of the definition 2101 that is an example of the window component definition 403. Although holding the window transition definition 404 in the window component definition 403 in this implementation, the program development apparatus 101 may hold the window transition definition 404 in the action 405.

If it is determined that the setting of the action item loaded in step S701 involves window transition, the process proceeds to step S703, and if it is determined that the setting of the action item loaded in step S701 involves no window transition, the process proceeds to step S704.

When proceeding to step S703, the program development apparatus 101 displays a transition window caused by window transition involved by the setting of the action item loaded in step S701. Specifically, a window 1300 of FIG. 13 that is a window set for “nextUi” of the definition 2101 is displayed. Note that a prototype data display component 1302 of the transition window of FIG. 13 has also been set in advance by the developer operation (step S601). Note that the window such as the prototype data display component 1302 may be displayed by a display scheme of rewriting the currently displayed window definition editor unit 421 or may be a display scheme of starting a new window definition editor unit 421.

The initial display action of the window (transition window) displayed in the window definition editor unit 421 is loaded, and this is defined as an action designated by the developer. After this process, the process proceeds to step S704.

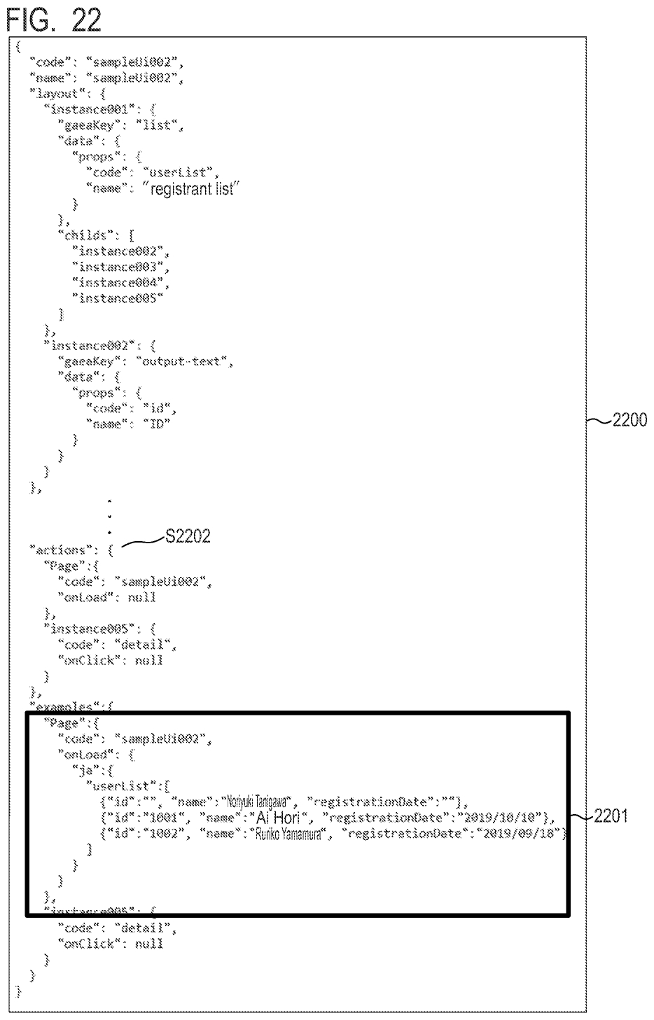

In step S704, the program development apparatus 101 displays the action loaded in S701 or the prototype data already set in the action loaded in S703 (for example, if data such as prototype data 2201 of FIG. 22 has already been set, then the data) on the screen.

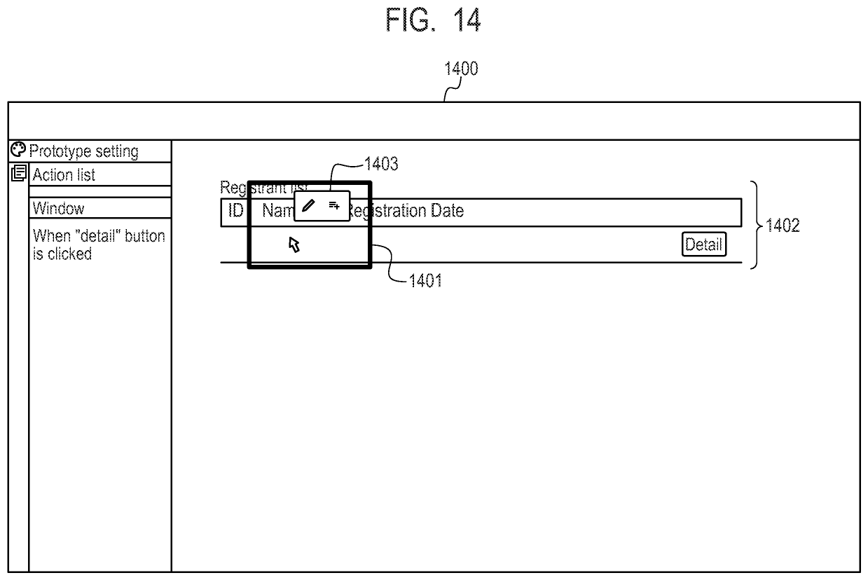

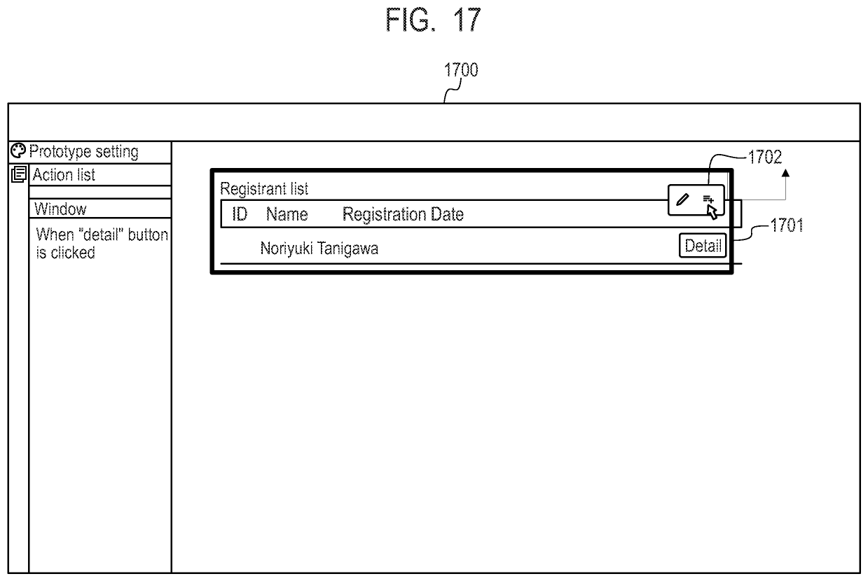

Next, in step S705, the program development apparatus 101 accepts selection of a prototype data display component from the developer. The prototype data display component herein refers to a component for which data (prototype data) is displayed in advance before a prototype application is operated. Specifically, as an example, prototype data is displayed in a list such as the prototype data display component 1302 of a transition window of FIG. 13 displayed in the window definition editor unit 421. In a prototype data display component 1402 of FIG. 14 that is the same drawing as FIG. 13, selection of a prototype data display component can be accepted when a mouse (not illustrated) is right-clicked on the “Name” field, for example and an edition button 1403 is pressed. Further, after the whole list is selected as with a prototype data display component 1701 of FIG. 17, when a table input button 1702 is pressed, the whole list of the prototype data display component 1701 can be selected as selection of the prototype data display component.

In next step S706, the program development apparatus 101 accepts entry of prototype data from the developer. Specifically, a prototype data input dialog 1501 of FIG. 15 that is an example of the prototype data input unit 425 is displayed. The prototype data input dialog 1501 is a prototype data input dialog displayed when the edition button 1403 is pressed in the “Name” field in the popup item 1401 of FIG. 14. The case of the prototype data input dialog 1501 is an example in which prototype data of “Noriyuki Tanigawa” is input in the “Name” field by the developer. After the value is input by the developer, it is determined whether or not the input of step S707 is finalized in response to pressing of the “OK” button in the prototype data input dialog 1501.

Further, as another example of step S706, an example of the prototype data input unit 425 will be described with reference to FIG. 18.

A prototype data input dialog 1801 of FIG. 18 is a dialog displayed when the table input button 1702 is pressed in FIG. 17. Input of a group of data to be displayed in a list displayed in the prototype data display component 1701 is accepted in a text entry field of the prototype data input dialog 1801. In the case of the prototype data input dialog 1801, data of “(blank)”, “Noriyuki Tanigawa”, and “(blank)” are input in the first row, data of “1001”, “Ai Hori”, and “2019/10/10” are input in the second row, and data of “1002”, “Ruriko Yamamura”, and “2019/09/18” are input in the third row. A CSV file or a spread sheet file may be selected from a file selection window (not illustrated) displayed by pressing of a file selection button 1802, and thereby the content of the selected file may be adapted to such data input.

After input of a value to the text entry field or data reflection after selection of a file from the developer, it is determined in response to pressing of the “OK” button 1803 whether or not the input in step S707 is finalized.

In step S706, designation of locale may be accepted in order to switch displayed prototype data in accordance with a language. Further, although the method of displaying a modal dialog is illustrated as a method of accepting input of prototype data, the method of accepting input may be a method of directly accepting input for a display component selected by the developer in S705 or may be collective input from an external file.

In next step S707, the program development apparatus 101 determines whether or not the prototype data input from the developer is finalized. Specifically, it is determined whether or not the “OK” button inside the prototype data input dialog 1501 of FIG. 15 or the “OK” button 1803 of FIG. 18 is pressed. Note that, when direct input to a component is accepted in the method of accepting the input in step S706, it is determined in accordance with whether or not focus on the component of interest is removed.

If it is determined that the prototype data input is finalized (the “OK” button is pressed), the process proceeds to step S708, and if it is determined that the prototype data input is not finalized, the process proceeds to step S706.

In step S708, the program development apparatus 101 writes prototype data, which has been input by the developer, to the window definition 402. Specifically, the prototype data is written to the prototype data 2201 that is an example of the prototype data 406 associated with the action 405 of the window definition 402.

Note that, in this method, no change can be made to data to be displayed on the post-transition window due to an action to be performed. This is because prototype data is held for an initial display action on the post-transition window. However, prototype data to be displayed in the post-transition window may be held on the side of an action to be performed, and thereby a change of data to be displayed on the post-transition window due to an action to be performed may be made possible. Specifically, objects below the “onLoad” of the prototype data 2201 may be held below the “onClick” of the definition 2103, and thereby the previous button that has caused transition of a window (for example, the “Register” button arranged in a window 1000 of FIG. 10) may be responsible for data to be displayed in a post-transition window.

In such a way, it is possible to recognize the overview as to what operations are performed as a mock-up before creating application software that actually operates (for example, before searching a database, and drawing a diagram from extracted data) by causing windows to transition on an action event basis with windows having the prototype data displayed therein to display each window on the prototype application.

This is the end of the description of FIG. 7.

Next, details of the process of step S507 will be described with reference to FIG. 8.

FIG. 8 is an example of a flowchart illustrating a flow of a process of generating a source code of a prototype application of web application software. Note that each of step of the flowchart described below is executed by the CPU 201 of the program development apparatus 101.

The flowchart of FIG. 8 represents a flow of the process started when the process proceeds to step S507 in the flowchart of FIG. 5.

First, in step S801, the program development apparatus 101 loads the application definition 401 designated by the developer from the repository definition unit 400. The repository definition analysis unit 411 analyzes and then stores the loaded definition in the ROM 203, and the analyzed definition is referenced by each generation unit as needed.

In step S802, the program development apparatus 101 loads the window definition 402 included in the application definition 401 loaded in step S801 from the repository definition unit 400.

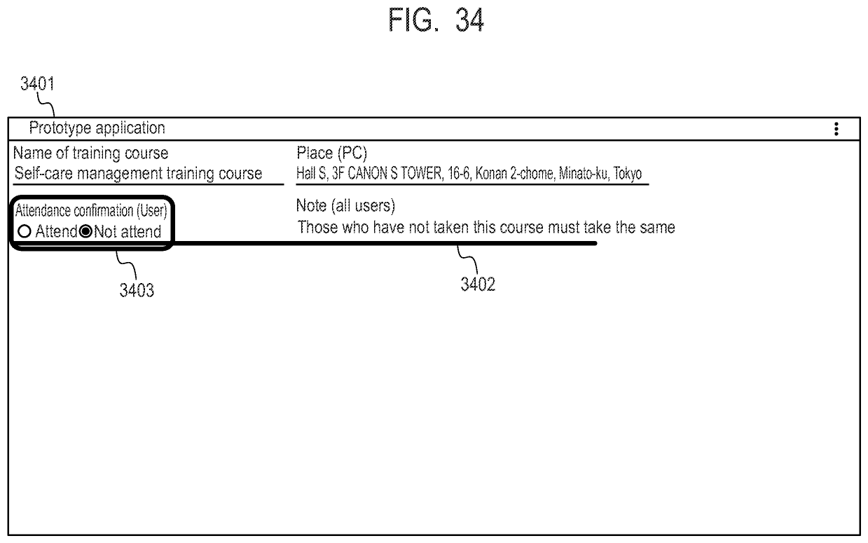

In step S802, in loading the window definition, information on display authority defined for respective window display items (items) is also acquired. This is described with reference to an example of FIG. 34. In FIG. 34, when a row where a display item (item) is changed in accordance with user authority is defined as a portion of underline 3402, information that associates a user authority name 821 in display authority data 820 of FIG. 8 with an input/output permission item 822 corresponding to the user authority name 821 or the like are acquired. Display authority data 820 of FIG. 8 is information on display authority defined in “Attendance confirmation” that is one of the window display items (items) included in the window of FIG. 34. In the case of the display authority data 820 of FIG. 8, authority names of “User (user)”, “Admin (administrator)”, and “Guest (guest)” as user authority and input/output permission items corresponding to respective authority names are defined. As the input/output permission item, each element item to be displayed is defined in association with authority out of a group of element items (Note, Attendance confirmation (User), Attendance confirmation (Admin), Update button) included in the window display item “Attendance confirmation” of FIG. 34. Note that this display item definition information may be information defining input/output display permission (an element item to be displayed in accordance with authority out of a group of element items (Note, Attendance confirmation (User), Attendance confirmation (Admin), Update button) included in the field of “Attendance confirmation”). Further, this display item definition information may define an input/output display prohibited item (an element item not to be displayed in accordance with authority out of a group of element items (Note, Attendance confirmation (User), Attendance confirmation (Admin), Update button) included in the field of “Attendance confirmation”). Further, display items may be defined collectively for display authority or may be defined individually on a display item basis as with the display authority data 820.

In step S803, the program development apparatus 101 loads the window component definition 403 included in the window definition 402 loaded in step S802 from the repository definition unit 400.

In step S804, the program development apparatus 101 loads the window transition definition 404 included in the window definition 402 loaded in step S802 from the repository definition unit 400.

In step S805, the program development apparatus 101 collects authority (role) associated with the display item acquired in step S802. For example, user authority data 830 is acquired.

In step S806, the program development apparatus 101 loads the prototype data 406 included in the window definition 402 loaded in step S802 from the repository definition unit 400. The data in the window definition 402 loaded herein is data of “examples” of FIG. 21 or FIG. 22 corresponding to the prototype data, and data of “actions”, that is, data for actual environment is not used. By having these two data, it is possible to create the window definition of prototype data and the window definition of the actual environment in a shared manner, and it is possible to define an application software window created for a mock-up as an application software window as it stands.

In step S807, the program development apparatus 101 generates a source code of a prototype application at the prototype code generation unit 412 based on information loaded in step S801 to step S806. The source code to be generated also includes a source code for a prototype operation panel (a prototype operation panel 3102 of FIG. 31 or the like) displayed when the prototype application is started.

FIG. 31 represents an example of a prototype display window (display window caused by prototype application) in the present embodiment. FIG. 31 is a display example of a prototype operation panel displayed in the initial window when prototype application software is started in accordance with the source code generated in S807. The prototype operation panel is an operation panel used for setting how to display the prototype application window 442 that emulates window transition of application software for the actual environment and is displayed by the prototype application.

The prototype operation panel will be described with reference FIG. 31. The prototype operation panel 3102 of FIG. 31 is a panel window that accepts, from a user (for example, a developer who performs demonstration for a customer by using a prototype of application software under development), an instruction of display settings or transition settings applied when a prototype window is displayed or a prototype window is caused to transition and displayed. The prototype operation panel 3102 may be used for setting a display device (a PC, a tablet, a smartphone, or the like) or the orientation of a screen of a display device, user's access authority (Admin authority (administrator authority), User authority (general user authority), or the like), whether or not to display a processing time at a server, whether or not to display an error if any, or the like. The display in a prototype application is changed as follows in accordance with these settings set in accordance with a user operation on the prototype operation panel. That is, the size and the orientation of the window is changed in accordance with settings of the display device and the orientation of the screen of the display device. The display content displayed in the prototype application is changed in accordance with a setting of user's access authority. Whether or not display that virtualizes a processing time at a server is performed is changed in accordance with a setting as to whether or not to display a processing time at the server. Whether or not display that virtualizes occurrence of an error is performed is changed in accordance with a setting whether or not to display an error if any. The display device setting can be set by a display device setting item 3111, the user authority setting can be set by an authority setting item 3121, the processing latency setting can be set by a processing time setting item 3131, and the error display setting can be set by an error setting item 3141. For example, the display device setting (window size setting) can be set to a PC by an operation to press (click) a button 3112 used for setting the window size to PC.

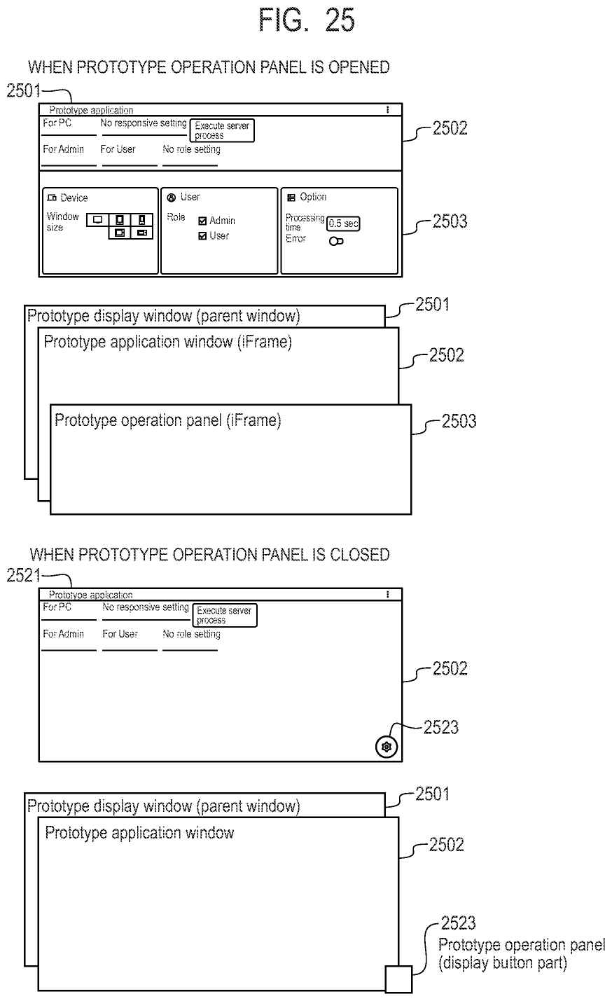

The relationship between a prototype application window and the prototype operation panel 3102 when the prototype operation panel 3102 is opened will be described with reference to FIG. 25 and FIG. 31.

FIG. 25 is a diagram illustrating a relationship between prototype application windows and a prototype operation panel.

A prototype display window 2501 that is a base of a parent window is a parent window displayed on the browser, and a prototype application window 2502 is displayed with iFrame in the parent window. Furthermore, a prototype operation panel 2503 (that is the same as the prototype operation panel 3102 of FIG. 31) is displayed over the prototype application window 2502, and a part of the prototype application window 2502 and the whole prototype operation panel 2503 are displayed in the prototype display window 2501 so as to enable simultaneous view.

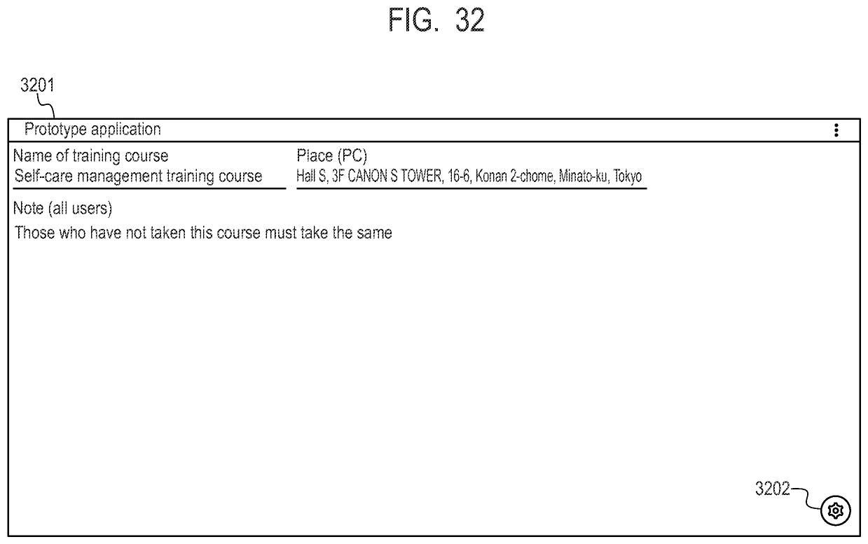

The prototype application window 2502 may be the major part of the prototype display window 2501 by hiding the prototype operation panel 3102 (2503). Once a setting operation from the user is accepted on the prototype operation panel 3102 as illustrated in FIG. 3 and an operation to reduce the size of (an operation to hide) the prototype operation panel 3102 (2503) is accepted via an operation on a reduction icon 3103 from the user, for example, a prototype application window 3201 as illustrated in FIG. 32 that is a window is displayed in which the prototype operation panel 3102 is hidden. This case corresponds to the prototype display window 2521 of FIG. 25, and the prototype application window 3201 of FIG. 32 corresponds to the prototype application window 2502 of FIG. 25. When returning to the window displaying the prototype operation panel 3102 (2503) from the prototype application window 3201 (2522), the user may press the button 3202 (2523) that is a button icon functioning as a prototype operation panel display button, and the window transitions to the prototype application window 3101 of FIG. 31 in which the prototype operation panel 3102 is displayed. That is, when the button 3202 (the icon 2523 of FIG. 25) displayed in the prototype application window 3201 (the prototype application window 2502 of FIG. 25) is operated, the display state returns to the display state of FIG. 31 (the display state of the prototype display window 2501 of FIG. 25), and the prototype operation panel 3102 (the prototype operation panel 2503 of FIG. 25) is displayed again. Reference is now made back to the description of the flowchart of FIG. 8.

The source code generated in step S807 is a source code of TypeScript started when the prototype operation panel is operated and storage region of the browser storing the operation (Web Storage or Cookie information) is changed.

Next, in step S808, the program development apparatus 101 generates a source code used for changing the window display on user authority basis. The generated source code is a source code of a program to determine user authority and control displaying/hiding of a window component to which the user authority is applied. That is, step S808 is a process of generating a program used for displaying a prototype (trial) window when user authority is set.

In step S809, the program development apparatus 101 generates a source code used for reproducing a window display occurring when a server is connected. The generated source code is a source code of a program portion that reflects the content set in the processing time setting item 3131 or the error setting item 3141 in the option setting field of the prototype operation panel 3102 to display the prototype display window. This is an example of the source code executed when a value of the processing time (processing latency) is input to the processing time setting item 3131 or when an error setting is set to ON in the error setting item 3141, and this source code forms a program to display a prototype (trial) window reflecting processing settings of a pseudo server acquired from a storage region of a browser. That is, step S809 is a process of generating a program used for reproducing pseudo communication or the server condition when communicating with the server.

In step S810, the program development apparatus 101 generates a program used for displaying the prototype application window 2502 (iFrame) while reflecting the content set in the display device setting item 3111 of the prototype operation panel 2503 (3102). For example, the generated source code is a source code of TypeScript used for displaying the prototype application window 2502 in different size and layout in accordance with whether the setting is set as a PC or a smartphone in the display device setting item 3111 of the prototype operation panel 3102 or the like.

After the source codes described above are generated, the process of the flowchart of FIG. 8 ends. Note that, although the source codes generated in S807 to S810 are of TypeScript as an example, the source codes written in another language may be used, and source codes written in JavaScript or the like may be used.

This is the end of the description of FIG. 8.

Next, a flow of the process when executing the prototype application deployed in step S509 of FIG. 5 and starting communication with a web browser (450) of the client apparatus 104 will be described with reference to FIG. 9. Note that the web browser started in step S511 of the program development apparatus 101 as illustrated in FIG. 5 may start communication with the deployed prototype display window application, or the web browser started at the client apparatus 104 as illustrated in FIG. 9 may start communication with the deployed execution server 102.

FIG. 9 is a flowchart illustrating an example of the operation in which information for displaying the prototype display window 440 deployed in step S509 of FIG. 5 is downloaded to and executed by the client apparatus 104. Note that each step of the flowchart described below is executed by the CPU 201 of the client apparatus 104.

The flowchart of FIG. 9 represents a flow of the process started when the user accesses the prototype display window 440 from the web browser 450 of the client apparatus 104 after the prototype display window 440 is deployed to the execution server 102 (430).

In step S901, the client apparatus 104 first loads browser locale information. With this locale information, it is possible to switch the display language of prototype data.

In step S902, the client apparatus 104 downloads, from the execution server 102 (430), a single page application (SPA) by which prototype display windows (the application software generated in steps S807 to S810 of FIG. 8) are operated. Note that, although described as an SPA in the present embodiment, the prototype display window 440 is not necessarily required to be an SPA and may be designed to communicate with the execution server 102 in response to a window transition command, and in such a case, the initial window information on the prototype application is downloaded.

Further, in step S902, the client apparatus 104 acquires user authority information on the prototype application.

Furthermore, in step S902, the client apparatus 104 starts (displays) the prototype display window 2501 (prototype display window 440) from the program acquired from the execution server 102 (430). That is, step S902 is a step of performing a process of downloading and starting a program used for displaying a window such as the prototype application window 3101 of FIG. 31.

In step S903, the client apparatus 104 starts the prototype application window 2502 of the iFrame part of the prototype display window 2501. The display example of the window being started is the prototype application window 3201 of FIG. 32. However, the prototype operation panel 3102 is displayed on the upper layer in next step S904 (in a relationship similar to that of the prototype application window 2502 and the prototype operation panel 2503 in FIG. 25).

In step S904, the client apparatus 104 starts the prototype operation panel (iFrame) 2503 of the iFrame part of the prototype display window 2501. Accordingly, as illustrated in FIG. 31, the prototype operation panel 3102 is displayed over the prototype application window 3101. By changing the setting displayed in the prototype operation panel 3102, it is possible to control a display setting of the prototype application or a transition setting of the window.

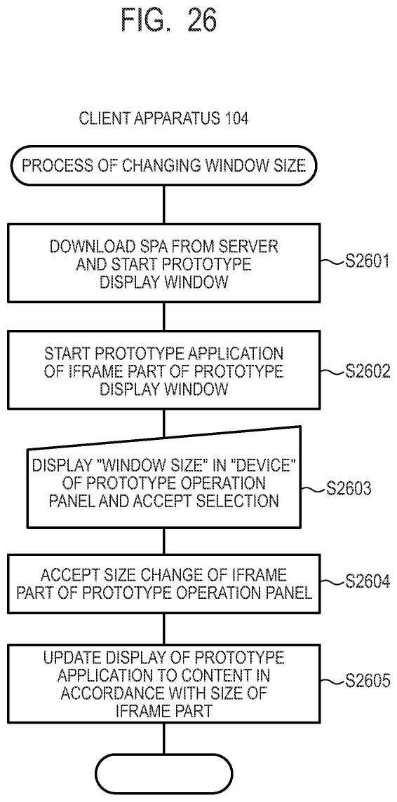

In step S905, the client apparatus 104 performs display to change the display window of the prototype application window 3201 (442) or change a transitioning window in accordance with respective settings input to the prototype operation panel 3102. The process of the window display of the prototype display window 440 or the transitioning window display in accordance with respective settings will be described later with reference to FIG. 26 to FIG. 29, respectively.

Next, in step S906, the client apparatus 104 waits for an instruction from the developer as to whether or not to stop the reproduction of the application software performed by the prototype application. If the reproduction of the application software is stopped, this flowchart ends, and if an instruction for performing reproduction once again is accepted, the process returns to step S902.

Next, as the details of the process of step S905, the flow of the process of displaying the display window of the prototype application window 3201 (442) or changing a transitioning window in accordance with respective settings input to the prototype operation panel 3102 will be described with reference to FIG. 26 to FIG. 29. The process of FIG. 26 to FIG. 29 is implemented by a program based on the source code generated in the process of FIG. 8 (that is, the prototype application). Note that respective settings correspond to reproduction of switching of display devices, change of user authority, reproduction of a processing time in relation to a server, and reproduction in a case of occurrence of an error.

FIG. 26 is a flowchart illustrating a flow of the process when switching display devices. Note that each step of the flowchart described below is executed by the CPU 201 of the client apparatus 104.

The flowchart of FIG. 26 is a flowchart started when there is access from the user via the web browser 450 of the client apparatus 104 and the SPA of the prototype display window 440 is downloaded to the web browser 450. Note that the description of a part of FIG. 26 to FIG. 29 is duplicated with the description of FIG. 9.

The process of steps S2601 and S2602 is the same as the process of steps S902 and S903 of FIG. 9.

In step S2603, the client apparatus 104 starts the prototype operation panel (iFrame) 2503 of the iFrame part of the prototype display window 2501. Up to this step, the process is the same as the process of step S904 of FIG. 9. The following process is the details of the process of step S905 of FIG. 9.

In a state where the prototype operation panel 3102 is displayed, when there is an operation on the display device setting item 3111 from the user and the display device setting (window size setting) is changed, the process proceeds to next step S2604. In the display device setting item 3111, various terminals whose window size has been predefined (a PC, a tablet (portrait orientation), a tablet (landscape orientation), a smartphone (portrait orientation), a smartphone (landscape orientation)) are displayed as choices that can be set. For a tablet or a smartphone, any one of the portrait orientation and the landscape orientation can be selected and set. The reason why the portrait orientation and the landscape orientation are made settable is that the tablet and the smartphone can be controlled for display in any of the portrait orientation and the landscape orientation.

Turning back to the description of the flowchart of FIG. 26, when the process proceeds to next step S2604, the client apparatus 104 accepts an instruction for a change to the window size of the device changed on the prototype operation panel 3102.

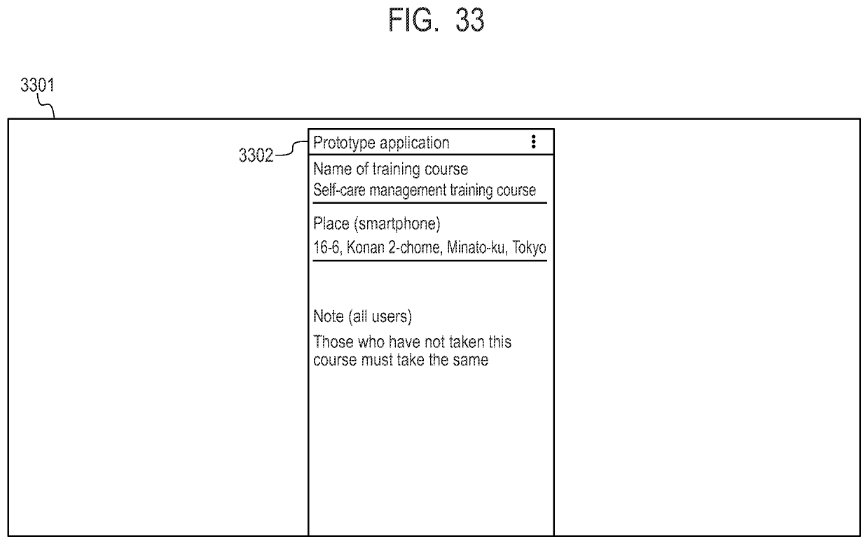

In step S2605, the client apparatus 104 displays the prototype application window 2502 so that the iFrame part matches the size of the device accepted in step S2604. FIG. 33 illustrates a display example of the prototype application window 2502 in a case of setting of a smartphone (portrait orientation).

The prototype application window 3301 of FIG. 33 is displayed within a range of the region 3302 corresponding to the smartphone size. Even in a case of a window displayed in the smartphone size, a process of prototype application as trial is executed. For example, when a predetermined button is pressed, a transition window reflecting prototype data in accordance with the pressing action can be displayed.

With the process described above, it is possible to easily create an application of a prototype in which the display form is changed on a device basis.

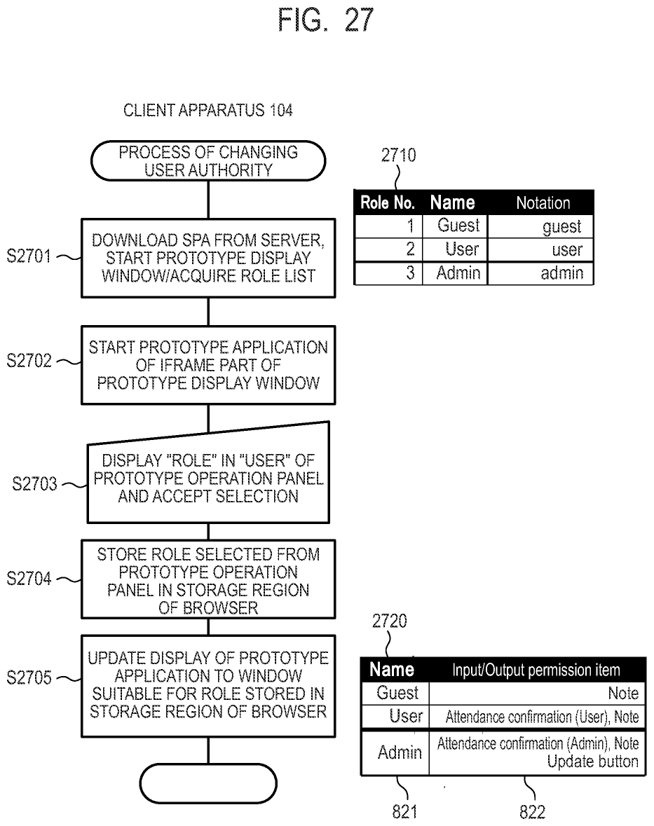

Next, a flow of the process of changing window display when user authority is changed will be described with reference to FIG. 27.

FIG. 27 is a flowchart illustrating a flow of the process when the user authority is switched. Note that each step of the flowchart described below is executed by the CPU 201 of the client apparatus 104.

The flowchart of FIG. 27 is a flowchart started when there is access from the user via the web browser 450 of the client apparatus 104 and the SPA of the prototype display window 440 is downloaded to the web browser 450.

The process of steps S2701 and S2702 is the same as the process of steps S902 and S903 of FIG. 9.

Note that, in step S2701, the client apparatus 104 acquires user authority information in the prototype application. An example of data to be acquired is data such as user authority data 2710, for example. This data is the same as the user authority data 830 acquired in step S805 when the prototype application is generated.

In step S2703, the client apparatus 104 starts the prototype operation panel (iFrame) 2503 of the iFrame part of the prototype display window 2501. Up to this step, the process is the same as the process of step S904 of FIG. 9. The following process is the details of the process of step S905 of FIG. 9. Note that the checkbox for setting user authority in the authority setting item 3121 of FIG. 31 is generated based on the user authority data 830 acquired in step S2710.

In a state where the prototype operation panel 3102 is displayed, when there is an operation on the authority setting item 3121 from the user and the authority setting is changed, the process proceeds to next step S2704.

When the process proceeds to step S2704, the client apparatus 104 stores, in the local storage of the browser, the value of the authority setting item 3121 changed in the prototype operation panel 3102.

In step S2705, the client apparatus 104 displays the prototype application window 2502 in the user authority setting stored in step S2704. FIG. 34 illustrates a display example of the prototype application window 2502 in a case of a setting of “user” in the authority setting item 3121.

Unlike in the prototype application window 3201 of FIG. 32, in the prototype application window 3401 of FIG. 34, new attendance confirmation (User) is additionally displayed to a portion indicated by the underline 3402. This is a conceptual diagram reflecting the data 820 of an input/output permission item for each user authority acquired in step S802 when the prototype application is generated. That is, because the setting of the authority setting item 3521 has been changed to “user”, the authority name (Name) corresponding to “user” of the user authority data 830 is “User”, the input/output permission items in the “User” authority are “Attendance confirmation (User)” and “Note”. Thus, in the prototype application window 3401 of FIG. 34, the attendance confirmation (User) field and the note field are displayed as indicated by the underline 3402.

Another example will be described.

In contrast to the above, it is also possible to check three checkboxes of “guest”, “user”, and “admin” in the authority setting item 3121 of FIG. 31. When the three checkboxes are checked, a “Note” field, an attendance confirmation (User) field, an attendance confirmation (Admin) field, and an update button are the input/output permission items according to the data 820 and the user authority data 830 of FIG. 8.

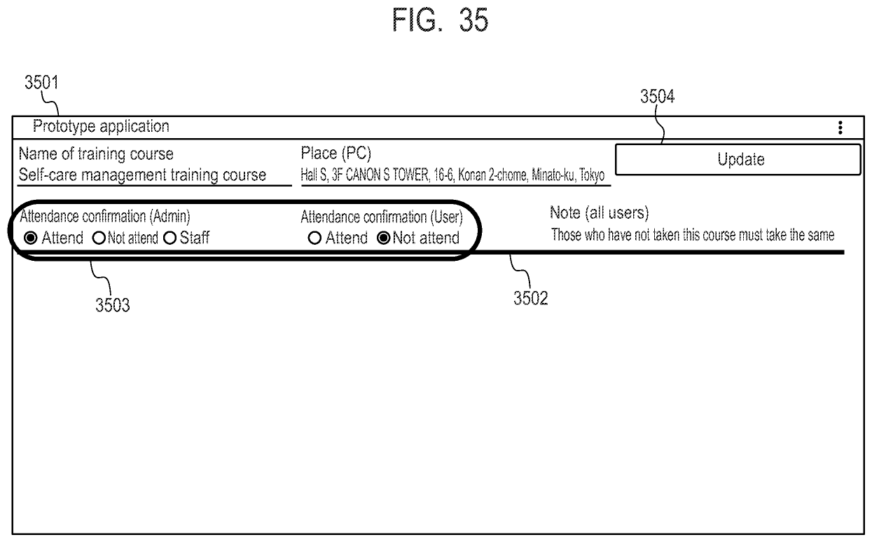

FIG. 35 is a display example displayed in a case of settings where three checkboxes of “guest”, “user”, and “admin” are checked in the authority setting item 3121.

Unlike in the prototype application window 3201 of FIG. 32, in the prototype application window 3501 of FIG. 35, new attendance confirmation (Admin) and attendance confirmation (User) 3503 are additionally displayed to a portion indicated by the underline 3502, and in addition, an update button 3504 is additionally displayed on the right side of the window.

The process described above has an advantage of making it possible to create application software of a prototype that performs window transition depending on a user's role. That is, if trial-type application software that performs only usual window transition were created, this would result in a pattern in which only predetermined window display or predetermined window transition can be made regardless of the user authority or the like. In the present embodiment, however, settings of a prototype operation panel for switching user authority are provided, it is possible to reproduce that the displayed window is switched on a user authority basis in accordance with switching of the user authority.

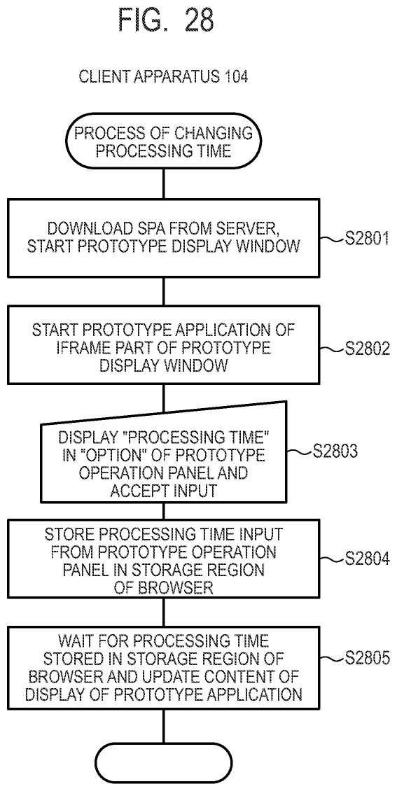

Next, a flow of the process of displaying reproduction of a processing time at a server will be described with reference to FIG. 28.

FIG. 28 is a flowchart illustrating a flow of the process when a processing time at a virtual server is changed. Note that each step of the flowchart described below is executed by the CPU 201 of the client apparatus 104.

The flowchart of FIG. 28 is a flowchart started when there is access from the user via the web browser 450 of the client apparatus 104 and the SPA of the prototype display window 440 is downloaded to the web browser 450.

The process of steps S2801 and S2802 is the same as the process of steps S902 and S903 of FIG. 9.

In step S2803, the client apparatus 104 starts the prototype operation panel (iFrame) 2503 of the iFrame part of the prototype display window 2501. Up to this step, the process is the same as the process of step S904 of FIG. 9. The following process is the details of the process of step S905 of FIG. 9.

In a state where the prototype operation panel 3102 is displayed, when there is an operation on the processing time setting item 3131 from the user and the processing time setting is changed, the process proceeds to next step S2804. The processing time setting item 3131 is a setting field used for reproducing display of window transition of the prototype application window 2502 taking the processing time at a server into consideration.

For example, in the processing time setting item 3131 of the prototype operation panel 3102 of FIG. 31, the value set to “0.2 seconds” can be changed to “2 seconds” in accordance with a user operation.

When the process proceeds to step S2804, the client apparatus 104 stores the value (for example, 2 seconds) of the processing time setting item 3131 of a server changed on a prototype operation panel 3902 in the local storage of the browser.

In next step S2805, the client apparatus 104 changes the prototype application window 2502 to a setting of waiting for the processing time stored in step S2804 and changes the prototype application to a prototype application for reproducing transition to the next window.

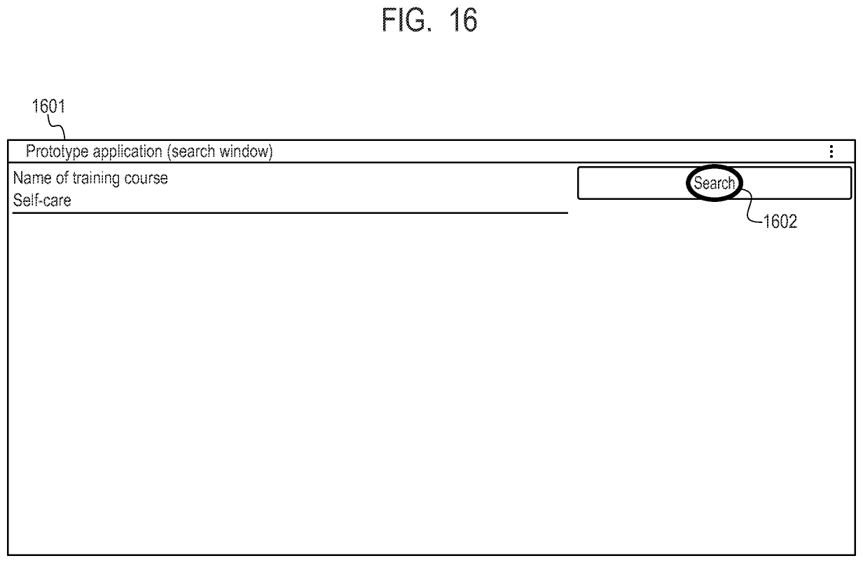

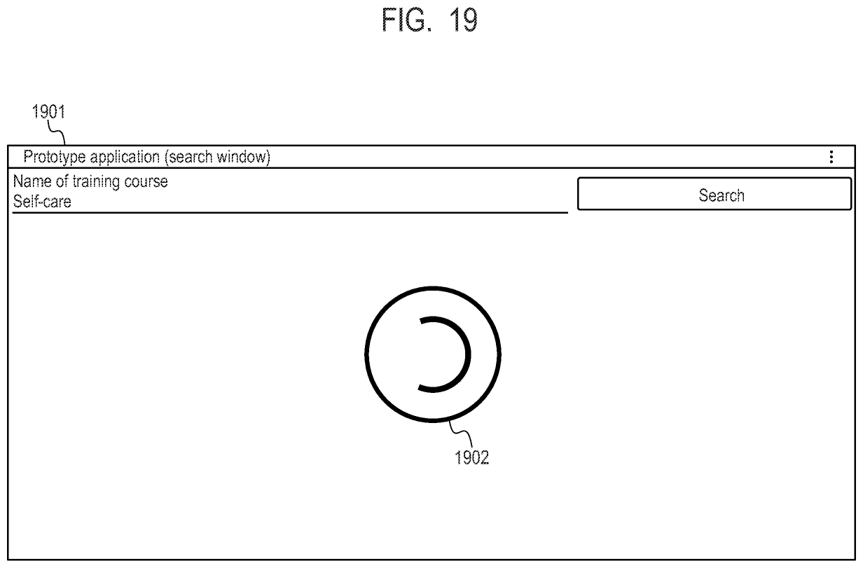

When the processing time is set to “2 seconds” in the processing time setting item 3131, for example, when a search button 1602 of a prototype application window 1601 of FIG. 16 is pressed, a display item 1902 with display as if a process is ongoing at the server is displayed for two seconds at the center as with the display example illustrated in FIG. 19. The time for displaying the display item 1902 indicating that the process is ongoing is the time set by the processing time setting item 3131. After the display item 1902 is displayed for the set time, FIG. 32 or the like that are the next transition windows are displayed.

The process described above has an advantage of making it possible to create application software of a prototype that virtually reproduces latency during window transition. That is, it is possible to reproduce the processing time occurring on the server side when application software for the actual environment (product application) is operated. For example, when a business user or a sales representative demonstrates a prototype application to a general user, it is possible to reproduce the time of a process with a server that would actually take a processing time and thus reproduce what window is displayed during the time of processing with the server. Since this prototype application is formed of an SPA, actual communication with the server is unnecessary. Thus, mere execution of a prototype application (window transition) does not take any processing time, and the window transitions with the prototype application one after another in response to user operations. Since the processing time at the server is not taken into consideration in the operation of application software for the actual environment (product application), a general user who views only the demonstration, in which no consideration is taken for the processing time at the server, and is satisfied therewith may feel a discrepancy regarding the performance of a developed and delivered product. With the demonstration in the present embodiment, since any processing time of a server can be freely set, this reduces a risk of a discrepancy regarding the performance of a developed and delivered product. Further, it is possible to change a virtual processing time at a server even during execution of a prototype application by displaying a prototype operation panel.

According to the present embodiment, the same window definition information as that of application software displayed in the actual environment is used for performing display also in a display window caused by a prototype application (for example, the prototype application window 1601 of FIG. 16), and thus the same window as the window in the actual environment can be displayed.

On the window of the actual environment caused by the application software, in response to an operation to press (click) a search button, that is, in response to an operation to provide an instruction for searching, a search process of searching a database on the Internet is performed based on a search keyword (“self-care”), which takes a processing time. After completion of the search process, display based on a search result is performed.

In contrast, in the display window caused by the prototype application (for example, FIG. 16), in response to pressing (click) of the search button 1602 being performed, which corresponds to a search instruction operation in the actual environment, prototype data that is a predefined display content is displayed as illustrated in FIG. 32 without searching of a database on the Internet and without communication with the Internet. The prototype data displayed in FIG. 32 is a display content emulating display based on a result of the search process. At this time, if the processing time is set to a value greater than zero by the processing time setting item 3131 (if the display item 1902 is set to be displayed), when the search button 1602 is pressed in FIG. 16, the display item 1902 virtually indicating that it is in the latency of a search process is displayed for the set time before transition to the display of FIG. 32. The display of FIG. 32 (display of prototype data that is a predefined display content) is then performed.

The prototype data is not data displayed based on a result of the search process.

Further, the time for displaying the display item 1902 is a time set by the user for the processing time setting item 3131, which is a time not related to the time required for a search process. Further, the time for displaying the display item 1902 is a time for virtually reproducing the time required for a search process.

Note that, if the processing time is set to zero by the processing time setting item 3131 or the display item 1902 is set to be hidden, when the search button 1602 is pressed in FIG. 16, the display transitions from FIG. 16 directly to FIG. 32 without displaying the display item 1902. In this transition, there is no waiting for a predetermined time.

Note that, when an operation (for example, click of “image processing button (not illustrated)”) corresponding to an execution instruction of a process (for example, a process of image processing) requiring a longer processing time than a search process is performed on the prototype application window, the display item 1902 may be displayed for a longer time than the time set by the processing time setting item 3131 so that the user can experience that it takes time (the latency becomes longer) due to the process. For example, the display item 1902 is displayed longer by five seconds than the time set by the processing time setting item 3131. A predefined display content emulating display of an execution result of the image processing is then displayed. Also in such a case, no image processing is executed because of the prototype application.

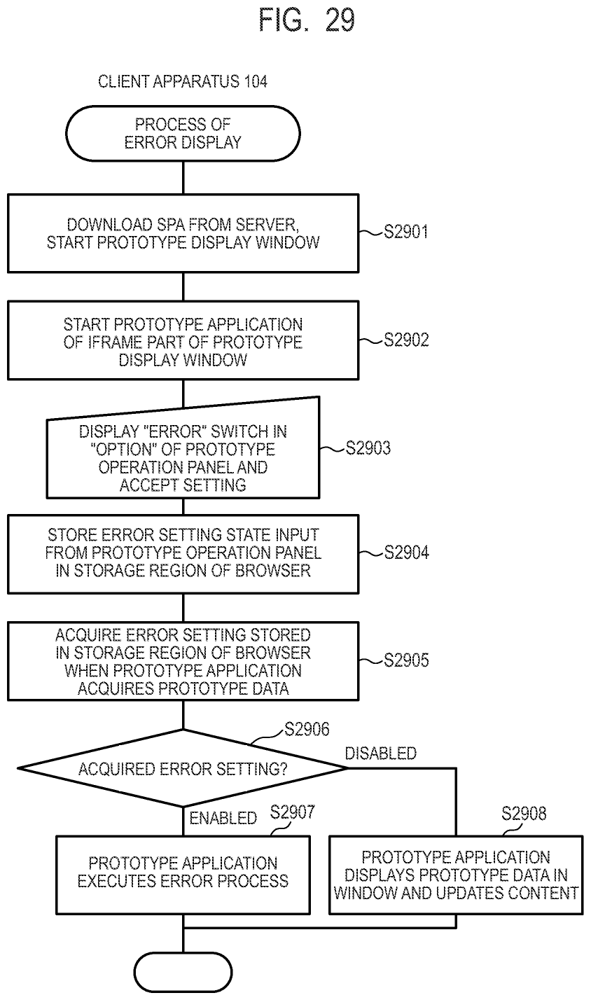

Next, a flow of the process of displaying reproduction when a server error, a communication error, or the like occur will be described with reference to FIG. 29.

Note that each step of the flowchart described below is executed by the CPU 201 of the client apparatus 104.

The flowchart of FIG. 29 is a flowchart started when there is access from the user via the web browser 450 of the client apparatus 104 and the SPA of the prototype display window 440 is downloaded to the web browser 450.

The process of steps S2901 and S2902 is the same as the process of steps S902 and S903 of FIG. 9.

In step S2903, the client apparatus 104 starts the prototype operation panel (iFrame) 2503 of the iFrame part of the prototype display window 2501. Up to this step, the process is the same as the process of step S904 of FIG. 9. The following process is the details of the process of step S905 of FIG. 9.

In a state where the prototype operation panel 3102 is displayed, when there is an operation on the error setting item 3141 from the user and the setting of occurrence of a virtual error is changed from “OFF” to “ON”, the process proceeds to next step S2904.

When the process proceeds to step S2904, the client apparatus 104 sets the “ON” value of the error setting item 3141, which has been changed on the prototype operation panel, to an error set state and stores the error set state in a local storage of the browser.

In step S2905, the client apparatus 104 acquires the error set state stored in step S2904 on the prototype application window 2502.

Next, a window transition instruction on the prototype application window is accepted from the user. In the case of FIG. 16, a window transition instruction is accepted when the search button 1602 is pressed (clicked). In response to accepting the window transition instruction, the process proceeds to next step S2806.

In next step S2906, the client apparatus 104 branches the process in accordance with whether the acquired error set state is ON (enabled) or OFF (disabled). If the error set state is ON, the process proceeds to step S2907, and if the error set state is OFF, the process proceeds to step S2908. When the process proceeds to step S2908, the client apparatus 104 causes the window to transition to FIG. 32 that is a usual transition window of the prototype application because the error set state is OFF.

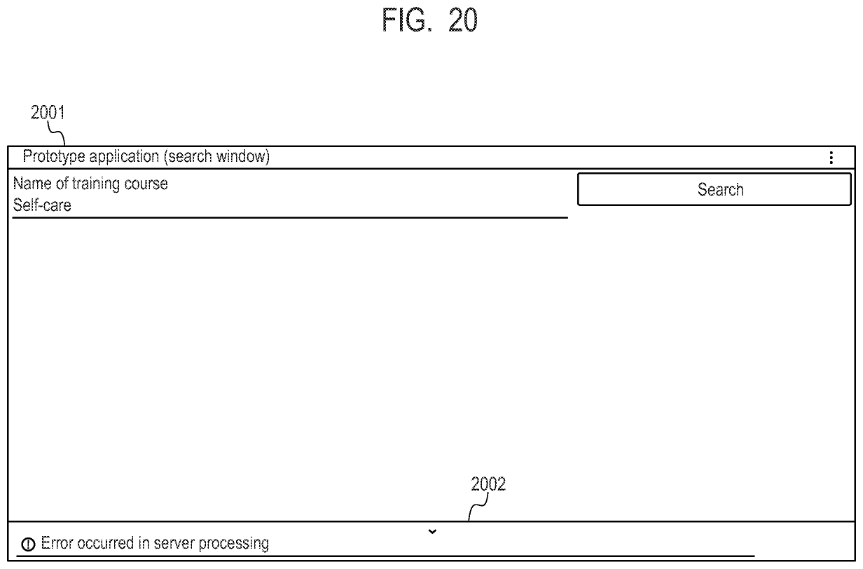

In contrast, when the process proceeds to step S2907, the client apparatus 104 proceeds with the process assuming that an error occurs in the prototype application. Specifically, the window of FIG. 16 transitions to the window of FIG. 20.

In FIG. 20, an error notification 2002 is displayed as the error display when an error occurs in a process caused by pressing of the search button 1602. The error notification 2002 includes a warning icon and a message of “Error occurred in server processing”.

With the process described above, it is possible to create a prototype application that can virtually reproduce an error window when window transition failed. That is, it is possible to virtually reproduce an error occurring on the server side or occurring during communication when application software for the actual environment (product application) is executed. Since this prototype application is formed of an SPA, actual communication with the server is unnecessary. Thus, mere execution of a prototype application (window transition) does not cause any server error or communication error to occur. Demands from a developer or a general user who intends to reproduce a display window displayed when an error occurs can be implemented by an SPA. Further, as a method of more realistically reproducing error display, the implementation is combined with reproduction of a virtual processing time at a server in FIG. 28.

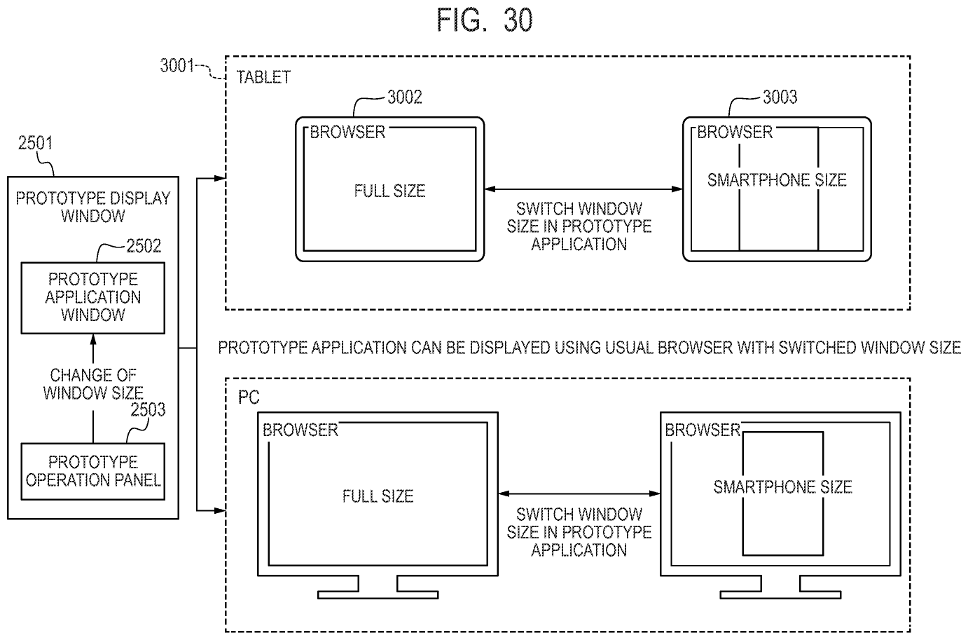

Since a prototype display window described above is formed of an SPA that can be started in a browser of various terminals, if a prototype application generated as with the prototype display window 2501 of FIG. 30 is downloaded to a PC or a tablet, it is possible to reproduce the prototype application window 2502 at respective terminals. For example, once a prototype application is downloaded to a tablet 3001, it is possible to operate the prototype operation panel 2503 or the prototype application window 2502 on the tablet. Even when a sales representative does not bring a PC, it is possible to operate the prototype display window application on the tablet. It is possible to operate a prototype application that reproduces a processing time of a server also on the tablet, and it is possible to reproduce display (3003) of a smartphone size in display (3002) on the tablet. Thus, if one terminal is brought for demonstration to a customer, windows to be displayed on any terminals or patterns of window transition can be reproduced.

As described above, the object of the present disclosure is, of course, achieved also when a storage medium storing a program that implements functions of the embodiment described above is supplied to a system or an apparatus, and a computer (or a CPU or an MPU) of the system or the apparatus reads the program stored in the storage medium and execute the read program.

In such a case, the individual program read from the storage medium implements a novel function of the present disclosure, and the storage medium storing the program forms the present disclosure.

As a storage medium for supplying a program, for example, a flexible disk, a hard disk, an optical disk, a magneto-optical disk, a CD-ROM, a CD-R, a DVD-ROM, a magnetic tape, a nonvolatile memory card, a ROM, an EEPROM, a silicon disk, or the like may be used.

Further, the present disclosure, of course, includes not only a case where a computer executes a read program and thereby the function of the embodiment described above is implemented but also a case where, based on an instruction from the program, operating system (OS) or the like running on a computer performs a part or the whole of the actual process and the function of the embodiment described above is implemented by the process.

Furthermore, the present disclosure, of course, includes a case where after a program read from a storage medium is written to a memory provided to a function expansion board inserted in a computer or a function expansion unit connected to a computer, a CPU or the like provided to the function expansion board or the function expansion unit performs a part or the whole of the actual process based on an instruction of the program code, and the function of the embodiment described above is implemented by the process.

Further, the present disclosure may be applied to a system formed of a plurality of devices or may be applied to an apparatus formed of a single device. Further, the present disclosure can be, of course, adapted to a case where a program is supplied to a system or an apparatus and thereby the disclosure is achieved. In such a case, when a storage medium storing a program that achieves the present disclosure is read to the system or the apparatus, the system or the apparatus can benefit from the advantageous effect of the present disclosure.

The form of the program described above may be a form of an object code, a program code executed by an interpreter, script data supplied to operating system (OS), or the like.

Furthermore, by downloading and reading a program used for achieving the present disclosure from a server, a database, or the like on a network via a communication program, the system or the apparatus can benefit from the advantageous effect of the present disclosure. Note that all the configurations combining respective embodiments described above and modified examples thereof are included in the present disclosure.

According to the present disclosure, it is possible to provide even virtual feeling of latency due to a time required for a process when virtually reproducing an operation of application software.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-007670, filed Jan. 21, 2021, and Japanese Patent Application No. 2021-192805, filed Nov. 29, 2021, which are hereby incorporated by reference herein in their entirety.

What is claimed is:

1. An information processing apparatus comprising at least one memory and at least one processor which function as:
a display control unit configured to perform control to display a window displayed by application software; and
a control unit configured to perform control to, in response to execution of a particular operation corresponding to an operation to provide an instruction for execution of a particular process, display a predefined display content while displaying the window without executing the particular process,
wherein the control unit is further configured to perform control to, in response to occurrence of the particular operation, display a predetermined display item for a predetermined time before displaying the predefined display content and then display the predefined display content, and the predetermined display item indicates that processing latency is ongoing.

2. The information processing apparatus according to claim 1, wherein the control unit is further configured to perform control to display the predefined display content after waiting for the predetermined time to elapse after the particular operation is performed regardless of a processing time required for displaying the predefined display content.

3. The information processing apparatus according to claim 1, wherein the predetermined time is a time for virtually reproducing a time required for the particular process.

4. The information processing apparatus according to claim 1, wherein the particular operation is an operation performed on a particular window component displayed in the window.

5. The information processing apparatus according to claim 1,
wherein the particular process is a process including searching a database,
wherein the predefined display content is a display content emulating display of a result of searching the database, and
wherein the control unit is further configured to perform control to display the predefined display content without searching the database.

6. The information processing apparatus according to claim 1,
wherein the particular process is a process including communicating with the Internet, and
wherein the control unit is further configured to perform control to display the predefined display content without communicating with the Internet.

7. The information processing apparatus according to claim 1, wherein the at least one memory and the at least one processor further function as a setting unit configured to set a setting regarding the predetermined time or the display of the predetermined display item in accordance with a user operation,
wherein the control unit is further configured to perform control to, when the predetermined time is set to zero by the setting unit or the predetermined display item is set to be hidden, display the predefined display content in response to the particular operation being performed while displaying the window by neither displaying the predetermined display item nor waiting for the predetermined time to elapse.

8. The information processing apparatus according to claim 1, wherein the predetermined time is user settable.

9. The information processing apparatus according to claim 1,
wherein the window is a window displayed as a prototype of the application software, and
wherein the control unit is further configured to perform control to, when the particular operation is performed when a window for actual implementation of the application software is being displayed, execute the particular process and perform display based on an execution result of the particular process.

10. The information processing apparatus according to claim 1, wherein the control unit is further configured to perform control to, in response to a second operation corresponding to an execution instruction of a second process being performed, display a display item for a second time that is longer than the predetermined time without executing the second process and then display a predefined display content emulating display of an execution result of the second process, the second process requires a longer time for processing than the particular process, and the display item indicates that processing latency is ongoing.

11. An information processing apparatus comprising at least one memory and at least one processor which function as:
an acquisition unit configured to acquire definition information in which a display item to be displayed on a first window of an application and a procedure of transitioning from the first window to a next second window are defined; and
a generation unit configured to generate instruction information used for providing an instruction to perform control to display the first window defined by the definition information acquired by the acquisition unit, display, for a predetermined time, a predetermined display item indicating that processing latency is ongoing in response to a particular operation being performed on the first window, and then cause transition to the second window defined by a procedure of the definition information acquired by the acquisition unit.

12. The information processing apparatus according to claim 11,
wherein the particular operation is an operation corresponding to an operation to provide an instruction for execution of a particular process, and
wherein the instruction information is used for providing an instruction to perform control to display the predetermined display item without executing the particular process even when the particular operation is performed and then causing transition to the second window.

13. The information processing apparatus according to claim 12, wherein the predetermined time is a time for virtually reproducing a time required for the particular process.

14. A control method of an information processing apparatus, the control method comprising:
a display control step of performing control to display a window displayed by application software; and
a control step of performing control to, in response to execution of a particular operation corresponding to an operation to provide an instruction for execution of a particular process, display a predefined display content while displaying the window without executing the particular process, wherein the control step includes performing control to, in response to occurrence of the particular operation, display a predetermined display item for a predetermined time before displaying the predefined display content and then display the predefined display content, and the predetermined display item indicates that processing latency is ongoing.

15. A control method of an information processing apparatus, the control method comprising:
an acquisition step of acquiring definition information in which a display item to be displayed on a first window of an application and a procedure of transitioning from the first window to a next second window are defined; and
a generation step of generating instruction information used for providing an instruction to perform control to display the first window defined by the definition information acquired by the acquisition step, display, for a predetermined time, a predetermined display item indicating that processing latency is ongoing in response to a particular operation being performed on the first window, and then cause transition to the second window defined by a procedure of the definition information acquired by the acquisition step.

16. A computer readable storage medium storing a program that causes a computer to function as each unit of the information processing apparatus according to claim 1.
